(19) United States
(12) Patent Application Publication
(10) Pub. No.: US 2025/0151023 A1
(43) Pub. Date: May 8, 2025

(54) SIDELINK POSITIONING REFERENCE SIGNAL PROCESSING

(71) Applicant: Lenovo (Singapore) Pte. Limited, Singapore (SG)

(72) Inventors: Robin Rajan Thomas, Frankfurt (DE); Karthikeyan Ganesan, Kronberg Im Taunus (DE); Abir Ben Hadj Fredj, Wiesbaden (DE); Colin Frank, Park Ridge, IL (US); Ankit Bhamri, Rödermark (DE); Ali Ramadan Ali, Kraiburg (DE)

(73) Assignee: Lenovo (Singapore) Pte. Limited, Singapore (SG)

(21) Appl. No.: 18/836,686

(22) PCT Filed: Feb. 3, 2023
(86) PCT No.: PCT/IB2023/050937

§ 371 Date: Aug. 7, 2024

Related U.S. Application Data
(60) Provisional application No. 63/307,463, filed on Feb. 7, 2022.

(51) Int. Cl. H04W 64/00; H04W 72/25

(52) U.S. Cl. CPC H04W 64/003; H04W 72/25

(57) ABSTRACT

Various aspects of the disclosure relate to sidelink positioning reference signal (PRS) processing. A configuring device transmits a request message requesting sidelink PRS processing capability of a responding device, and receive a response message indicating the sidelink PRS processing capability. The configuring device can configure a sidelink PRS configuration indicating a duration and priority associated with processing a sidelink PRS with respect to an additional sidelink signal received by the responding device, and transmit the sidelink PRS configuration to the responding device. The responding device can receive the request message to indicate the sidelink PRS processing capability of the device, and transmit the response message indicating the sidelink PRS processing capability. The responding device can receive the sidelink PRS configuration indicating the duration and priority associated with processing the sidelink PRS with respect to the additional sidelink signal, and process the sidelink PRS based on the received sidelink PRS configuration.

### RELATED APPLICATION

This application claims priority to U.S. Patent Application Ser. No. 63/307,463 filed Feb. 7, 2022 entitled “Sidelink Positioning Reference Signal Processing,” the disclosure of which is incorporated by reference herein in its entirety.

### TECHNICAL FIELD

The present disclosure relates to wireless communications, and more specifically to sidelink positioning reference signal processing.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

The wireless communications system enables UE-assisted and UE-based positioning methods in the third generation partnership project (3GPP) positioning framework. Typically, a UE can perform measurement and processing of the Uu interface positioning reference signals prior to reporting the measurements to a location server in the wireless communications system. However, UE-to-UE range and orientation determinations are not supported, which would facilitate relative positioning applications across other services, such as for vehicle-to-everything (V2X), public safety, industrial Internet of things (IIoT), commercial, and other applications.

### SUMMARY

The present disclosure relates to methods, apparatuses, and systems that support sidelink positioning reference signal processing. By utilizing the described techniques, a network entity (e.g., a UE or other sidelink enabled device) and a sidelink device are operable to implement various aspects of the sidelink positioning reference signal processing. Either of the network entity (e.g., a UE or other device) and/or the sidelink device may be implemented in the wireless communications system as a UE, a base station, a roadside unit, an anchor UE, a target UE, a reference UE, a location server, an unmanned or uncrewed ariel vehicle (UAV) (e.g., a drone), and/or as any other type of network devices or entities performing procedures for sidelink positioning processing. Aspects of the disclosure are directed to the processing functionality of sidelink reference signals in a standalone manner and with respect to other sidelink signals and/or channels. For instance, the network device can transmit a processing capabilities request to the sidelink device via a sidelink communication link. In various implementations, the processing capabilities request may be a request for sidelink PRS processing capabilities, or the processing capabilities request may be a request for Uu and sidelink PRS processing capabilities. The sidelink device receives the processing capabilities request from the network device, generates a response, and transmits a report as the sidelink PRS processing capabilities and/or the Uu and sidelink PRS processing capabilities of the sidelink device back to the network device.

Some implementations of the method and apparatuses described herein may include wireless communication at a device (e.g., a UE, responding device as an apparatus), and the device receives a request message to indicate a sidelink positioning reference signal (PRS) processing capability of the device. The device can transmit a response message indicating the sidelink PRS processing capability of the device based on the received request message. The device can also receive a sidelink PRS configuration indicating a respective duration and a respective priority associated with processing at least one sidelink PRS with respect to an additional sidelink signal, and process the sidelink PRS based on the received sidelink PRS configuration.

In some implementations of the method and apparatuses described herein, the responding device is a roadside unit, a reference UE, an anchor UE, or one or more UE configured for sidelink PRS processing. The device can receive the request message to indicate a joint sidelink and Uu interface PRS processing capability of the device, and transmit the response message indicating the joint sidelink and Uu interface PRS processing capability of the device. The device can also determine the joint sidelink and Uu interface PRS processing capability based on a number of sidelink PRS symbols and/or Uu interface PRS symbols that the device can jointly process and buffer during a configured slot duration. The device can jointly process sidelink PRS and Uu interface PRS in accordance with a Uu measurement gap configuration and/or jointly process sidelink PRS and Uu interface PRS on overlapping or partially overlapping positioning frequency layers. A separate sidelink measurement occasion can be defined during which to perform the sidelink PRS positioning measurements or the joint sidelink and Uu PRS measurements according to a measurement gap having a start time, a length, a repetition period, and an offset. The response message can indicate that the sidelink PRS processing capability includes information comprising sidelink PRS symbols that the device can process according to the sidelink PRS configuration. The response message can also indicate that the sidelink PRS processing capability includes information, such as an amount of sidelink PRS resources that the apparatus can be processed in a sidelink slot depending on a configured sidelink positioning frequency layer. The sidelink PRS configuration can include criteria of sidelink PRS prioritization as a first priority state of the sidelink PRS processing having a higher priority than the sidelink PRS data processing, or a second priority state of the sidelink PRS processing having a lower priority than the PRS data processing.

Some implementations of the method and apparatuses described herein may include wireless communication at a device (e.g., a network entity, configuring device as an apparatus), and the device transmits a request message to request a sidelink positioning reference signal (PRS) processing capability of a responding device. The device can receive a response message indicating the sidelink PRS processing capability of the responding device based on the transmitted request message. The device can also configure a sidelink PRS configuration indicating a respective duration and a respective priority associated with processing a sidelink PRS at the responding device with respect to an additional sidelink signal received by the responding device, and transmit the sidelink PRS configuration to the responding device.

In some implementations of the method and apparatuses described herein, the configuring device is a base station, a roadside unit, a location server, an anchor UE, a reference UE, or a target UE. The device can transmit the request message to request a joint sidelink and Uu interface PRS processing capability of the responding device, and receive the response message indicating the joint sidelink and Uu interface PRS processing capability of the responding device. The joint sidelink and Uu interface PRS processing capability of the responding device is based at least in part on a number of one or more sidelink PRS symbols or Uu interface PRS symbols that the responding device can jointly process and buffer during a configured slot duration. The device can also transmit the request message to the responding device as one of an unsolicited request or a solicited request. The device can configure the sidelink PRS configuration with a time duration during which the sidelink PRS has a defined priority with respect to a transmission of additional sidelink data or a non-positioning reference signal. The device can transmit the request message via unicast, groupcast, or broadcast signaling.

### BRIEF DESCRIPTION OF THE DRAWINGS

Various aspects of the present disclosure for sidelink positioning measurement procedures are described with reference to the following Figures. The same numbers may be used throughout to reference like features and components shown in the Figures.

FIG. 1 illustrates an example of a wireless communications system that supports sidelink positioning reference signal processing in accordance with aspects of the present disclosure.

FIG. 2 illustrates an example of absolute and relative positioning scenarios as related to sidelink positioning reference signal processing in accordance with aspects of the present disclosure.

FIG. 3 illustrates an example of a multi-cell RTT procedure as related to sidelink positioning measurement procedures in accordance with aspects of the present disclosure.

FIG. 4 illustrates an example of a system for existing relative range estimation as related to sidelink positioning measurement procedures in accordance with aspects of the present disclosure.

FIG. 5 illustrates an example of a system for NR beam-based positioning as related to sidelink positioning measurement procedures in accordance with aspects of the present disclosure.

FIG. 6 illustrates an example of an LTE positioning protocol (LPP) request location information message as related to sidelink positioning measurement procedures in accordance with aspects of the present disclosure.

FIG. 7 illustrates an example of a LPP provide location information message as related to sidelink positioning measurement procedures in accordance with aspects of the present disclosure.

FIG. 8 illustrates an example of a NR-DL-PRS-ProcessingCapability message as related to sidelink positioning reference signal processing in accordance with aspects of the present disclosure.

FIG. 9 illustrates an example of sidelink PRS processing capabilities for processing sidelink PRS resources that supports sidelink positioning reference signal processing in accordance with aspects of the present disclosure.

FIG. 10 illustrates an example of the NR-DL-PRS-ProcessingCapability message that supports sidelink positioning reference signal processing in accordance with aspects of the present disclosure.

FIG. 11 illustrates an example of unicast and groupcast signaling for unsolicited sidelink PRS processing capability message transfer that supports sidelink positioning reference signal processing in accordance with aspects of the present disclosure.

FIG. 12 illustrates an example of joint Uu and SL PRS processing capabilities for processing Uu and SL PRS resources that supports sidelink positioning reference signal processing in accordance with aspects of the present disclosure.

FIG. 13 illustrates an example of a sidelink prioritization processing window that supports sidelink positioning reference signal processing in accordance with aspects of the present disclosure.

FIG. 14 illustrates an example block diagram of components of a device (e.g., a responding device, sidelink implemented UE) that supports sidelink positioning reference signal processing in accordance with aspects of the present disclosure.

FIG. 15 illustrates an example block diagram of components of a device (e.g., a configuring device, sidelink network entity) that supports sidelink positioning reference signal processing in accordance with aspects of the present disclosure.

FIGS. 16-19 illustrate flowcharts of methods that support sidelink positioning reference signal processing in accordance with aspects of the present disclosure.

### DETAILED DESCRIPTION

Implementations of sidelink (SL) positioning reference signal (PRS) processing are described, such as related to aspects of the processing functionality of sidelink reference signals in a standalone manner and with respect to other sidelink signals and/or channels. This disclosure details several implementations supporting sidelink (PC5) varying sidelink PRS positioning processing capabilities. Given the wide range of hardware requirements and UE capabilities, different UEs may support different sidelink PRS processing capabilities. Aspects of the disclosure include implementations to define the sidelink PRS processing behaviour for UEs, such as for performing on sidelink positioning measurement and processing, and performing joint SL and Uu measurement and processing, including coordination of measurement gap with a sidelink PRS occasion. Additionally, the disclosure includes an implementation to request and report sidelink positioning processing capabilities for performing sidelink positioning including the number of sidelink PRS symbols in a given duration. The described aspects also provide for a centralized and decentralized sidelink prioritization processing window configuration, in which to process sidelink PRS with respect to other signals and/or channels. Further, the described aspects provide to perform sidelink PRS processing capability exchange in a variety of different coverage scenarios including in-coverage, partial coverage, and out-of-coverage.

Typically, a UE can perform measurement and processing of the Uu interface positioning reference signals prior to reporting the measurements to a location server in a wireless communications system. The conventional system supports UE-assisted and UE-based positioning methods in the 3GPP positioning framework. However, UE-to-UE range and orientation determinations are not supported, which would facilitate relative positioning applications across other services, such as for vehicle-to-everything (V2X), public safety, industrial Internet of things (IIoT), commercial, and other applications. Additionally, there are challenges to processing sidelink PRS in parallel with other existing sidelink data and reference signal transmissions. For the described sidelink positioning measurement procedures, timely and accurate measurements are essential to obtain high absolute and relative positioning accuracy. Unlike the traditional positioning, the described sidelink positioning takes into account moving and distributed nodes, varying mobility, the availability of anchor and non-anchor entities, uncertainty about the measurement, and so on. At the same time, the sidelink positioning provides the advantages of range and orientation estimation which is essential for tracking and position estimation for UEs with respect to other UEs.

Aspects of the disclosure include defining the sidelink processing capability exchange and configuring a prioritization processing window configuration. The described sidelink positioning reference signal processing accommodates different UEs with different capabilities, such as for sidelink PRS processing behavior for processing N symbols in T duration of time, and defining the signaling content for a sidelink UE performing positioning to indicate its processing behavior. Additionally, a sidelink UE or other sidelink-enabled device may jointly process Uu and SL PRS for enhanced position estimation. Further, a sidelink UE or other SL-enabled device may prioritize the processing of sidelink PRS and other sidelink signals and channels within a defined window or duration. In an implementation, the processing window configuration and processing capability exchange are defined for a different coverage scenarios, including in-coverage, partial coverage, and out-of-coverage.

Different UEs may have different processing capabilities depending on the cost, power consumption, and related requirements. It is therefore expected that all UEs may not have the same processing capabilities for sidelink PRS. The sidelink PRS processing is described based on different functionalities and different UE types in terms of the number of sidelink PRS symbols a UE can process in a given time duration, as well as to request and report sidelink positioning processing capabilities for performing sidelink positioning. In an implementation, the joint processing of Uu and SL PRS symbols can be defined based on defined criteria. Alternatively or in addition, a sidelink prioritization processing window configuration for Mode 1 and Mode 2 sidelink transmissions can be defined to enable a UE prioritizing sidelink PRS with respect to other sidelink channels and/or signals. In other implementations, the processing window configuration and sidelink PRS processing capability exchange are supported in the different coverage scenarios.

Aspects of the present disclosure are described in the context of a wireless communications system. Aspects of the present disclosure are further illustrated and described with reference to device diagrams and flowcharts that relate to sidelink positioning reference signal processing.

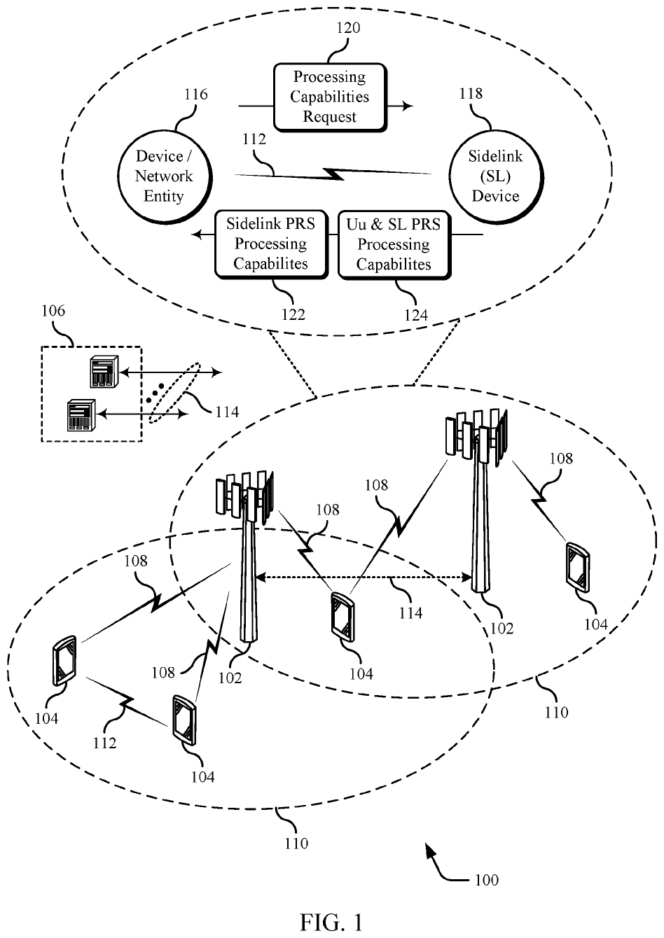

FIG. 1 illustrates an example of a wireless communications system 100 that supports sidelink positioning reference signal processing in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 118 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of a device 116 (e.g., a network entity) and a sidelink device 118 are operable to implement various aspects of sidelink positioning reference signal processing, as described herein. Either of the device 116 and/or the sidelink device 118 may be implemented in the wireless communications system 100 as a UE 104, a base station 102, a roadside unit, an anchor UE, a target UE, a reference UE, a location server, an unmanned or uncrewed ariel vehicle (UAV) (e.g., a drone), and/or as any other type of network devices or entities performing procedures for sidelink positioning measurement. Aspects of the disclosure are directed to the processing functionality of sidelink reference signals in a standalone manner and with respect to other sidelink signals and/or channels. For instance, the device 116 can communicate (e.g., transmit) a processing capabilities request 120 to the sidelink device 118 via a sidelink communication link 112. In various implementations, the processing capabilities request 120 may be a request for sidelink PRS processing capabilities, or the processing capabilities request may be a request for Uu and sidelink PRS processing capabilities. The sidelink device 118 receives the processing capabilities request 120 from the device 116 and generates a response. Accordingly, the sidelink device 118 communicates (e.g., transmits) a report as the sidelink PRS processing capabilities 122 and/or the Uu and sidelink PRS processing capabilities 124 of the sidelink device back to the network device 116.

With reference to new radio (NR) positioning based on NR Uu signals and SA architecture (e.g., beam-based transmissions), the target use cases also include commercial and regulatory (emergency services) scenarios. The 3GPP (release 17) defines the positioning performance requirements for commercial and IIoT use cases. For example, the positioning error requirement for end-to-end latency for a position estimate of a UE in a commercial use case is less than 100 ms, and in an IIoT use case is less than 100 ms, within the order of 10 ms being desired. However, these positioning performance requirements do not address obtaining a position estimate for a UE based on sidelink PRS.

The supported positioning techniques (release 16) are listed in Table1, and separate positioning techniques can be currently configured and performed based on the requirements of the location management function (LMF) and UE capabilities. The transmission of PRS enable the UE to perform UE positioning-related measurements to enable the computation of a UE's location estimate and are configured per transmission reception point (TRP), where a TRP may transmit one or more beams. Various RAT-dependent positioning techniques (also referred to as positioning methods, or positioning procedures) are supported for a UE, for (E-assisted, LMF-based, and/or for NG-RAN node assisted. The RAT-dependent positioning techniques that are supported include downlink-time difference of arrival (DL-TDOA), downlink-angle of departure (DL-AoD), multi-round trip time (multi-RTT), new radio enhanced cell-ID (NR E-CID); uplink-time difference of arrival (UL-TDOA); and uplink-angle of arrival (UL-AoA).

TABLE T1
Supported Rel-16 UE Positioning Methods

| | | | NG-RAN | |
|---|---|---|---|---|
| | UE- | UE-assisted, | node | |
| Method | based | LMF-based | assisted | SUPL |
| A-GNSS | Yes | Yes | No | Yes (UE-based |
| | | | | and UE-assisted) |
| OTDOA ^{Note1, Note 2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{Note1}
This includes TBS positioning based on PRS signals.
^{Note 2}
In this version of the specification only OTDOA based on LTE signals is supported.
^{Note 3}
Void.
^{Note 4}
This includes Cell-ID for NR method.
^{Note 5}
In this version of the specification only for TBS positioning based on MBS signals.
NOTE 6:
Void

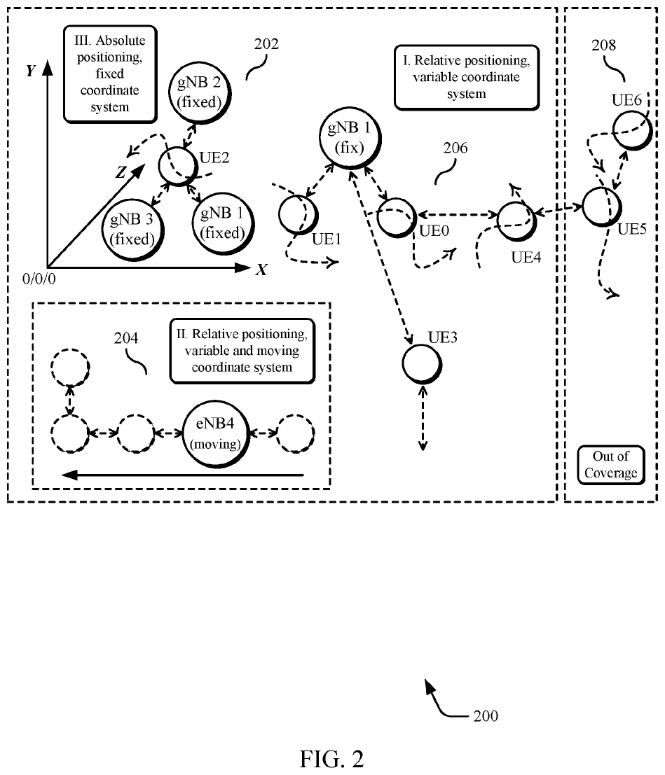

FIG. 2 illustrates an example 200 of absolute and relative positioning scenarios as related to sidelink positioning reference signal processing in accordance with aspects of the present disclosure. The network devices described with reference to example 200 may use and/or be implemented with the wireless communications system 100 and include UEs 104 and base stations 102 (e.g., eNB, gNB). The example 200 is an overview of absolute and relative positioning scenarios as defined in the architectural (stage 1) specifications using three different co-ordinate systems, including (III) a conventional absolute positioning, fixed coordinate system at 202; (II) a relative positioning, variable and moving coordinate system at 204; and (I) a relative positioning, variable coordinate system at 206. Notably, the relative positioning, variable coordinate system at 206 is based on relative device positions in a variable coordinate system, where the reference may be always changing with the multiple nodes that are moving in different directions. The example 200 also includes a scenario 208 for an out of coverage area in which UEs need to determine relative position with respect to each other.

With reference to RAT-dependent positioning techniques, the DL-TDOA positioning technique utilizes at least three network nodes for positioning based on triangulation. The DL-TDOA positioning method makes use of the downlink reference signal time difference (RSTD) (and optionally DL PRS RSRP) of downlink signals received from multiple transmission points (TPs) at the UE. The UE measures the downlink RSTD (and optionally DL PRS RSRP) of the received signals using assistance data received from the positioning server (also referred to herein as the location server), and the resulting measurements are used along with other configuration information to locate the UE in relation to the neighboring TPs.

The DL-AoD positioning technique makes use of the measured downlink PRS reference signal received power (RSRP) (DL PRS RSRP) of downlink signals received from multiple TPs at the UE. The UE measures the DL PRS RSRP of the received signals using assistance data received from the positioning server (also referred to herein as the location server), and the resulting measurements are used along with other configuration information to locate the UE in relation to the neighboring TPs.

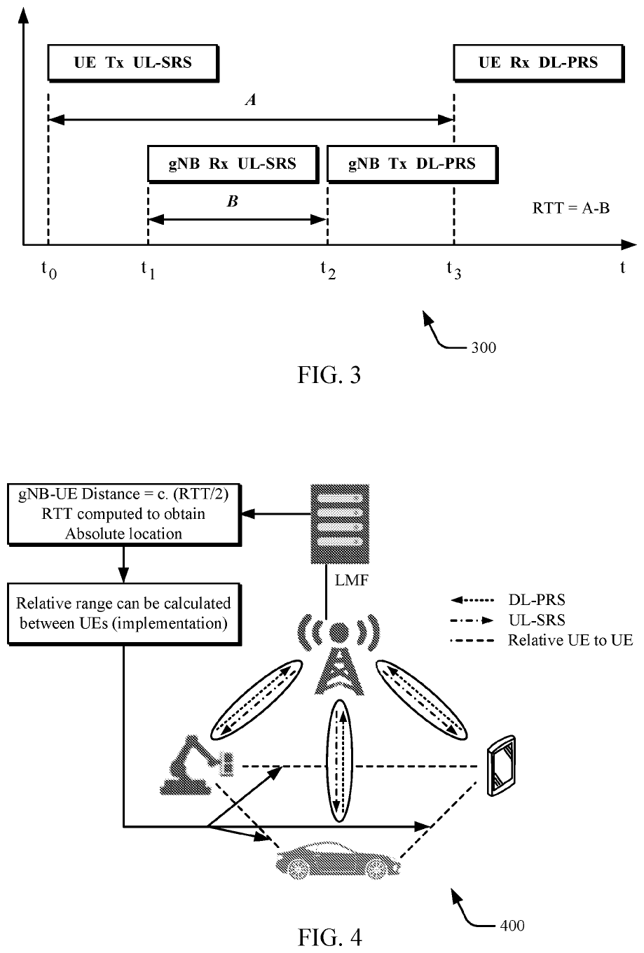

FIG. 3 illustrates an example 300 of a multi-cell RTT procedure as related to sidelink positioning reference signal processing in accordance with aspects of the present disclosure. The multi-RTT positioning technique makes use of the UE Rx-Tx measurements and DL PRS RSRP of downlink signals received from multiple TRPs, as measured by the UE and the measured gNB Rx-Tx measurements and uplink sounding reference signal (SRS) RSRP (UL SRS-RSRP) at multiple TRPs of uplink signals transmitted from UE. The UE measures the UE Rx-Tx measurements (and optionally DL PRS RSRP of the received signals) using assistance data received from the positioning server (also referred to herein as the location server), and the TRPs the gNB Rx-Tx measurements (and optionally UL SRS-RSRP of the received signals) using assistance data received from the positioning server. The measurements are used to determine the RTT at the positioning server, which are used to estimate the location of the UE. The multi-RTT is only supported for UE-assisted and NG-RAN assisted positioning techniques as noted in Table T1.

FIG. 4 illustrates an example of a system 400 for existing relative range estimation as related to sidelink positioning reference signal processing in accordance with aspects of the present disclosure. The system 400 illustrates the relative range estimation using the existing single gNB RTT positioning framework. The location server (LMIF) can configure measurements to the different UEs, and then the target UEs can report their measurements in a transparent way to the location server. The location server can compute the absolute location, but in order to get the relative distance between two of the UEs, it would need prior information, such as the locations of the target UEs.

For the NR enhanced cell ID (E-CID) positioning technique, the position of a UE is estimated with the knowledge of its serving ng-eNB, gNB, and cell, and is based on LTE signals. The information about the serving ng-eNB, gNB, and cell may be obtained by paging, registration, or other methods. The NR enhanced cell-ID (NR E-CID) positioning refers to techniques which use additional UE measurements and/or NR radio resources and other measurements to improve the UE location estimate using NR signals. Although enhanced cell-ID (E-CID) positioning may utilize some of the same measurements as the measurement control system in the radio resource control (RRC) protocol, the UE may not make additional measurements for the sole purpose of positioning (i.e., the positioning procedures do not supply a measurement configuration or measurement control message, and the UE reports the measurements that it has available rather than being required to take additional measurement actions).

The uplink time difference of arrival (UL-TDOA) positioning technique makes use of the UL-TDOA (and optionally UL SRS-RSRP) at multiple reception points (RPs) of uplink signals transmitted from UE. The RPs measure the UL-TDOA (and optionally UL SRS-RSRP) of the received signals using assistance data received from the positioning server, and the resulting measurements are used along with other configuration information to estimate the location of the UE. The uplink angle of arrival (UL-AoA) positioning technique makes use of the measured azimuth and the zenith of arrival at multiple RPs of uplink signals transmitted from UE. The RPs measure azimuth-AoA and zenith-AoA of the received signals using assistance data received from the positioning server (also referred to herein as the location server), and the resulting measurements are used along with other configuration information to estimate the location of the UE.

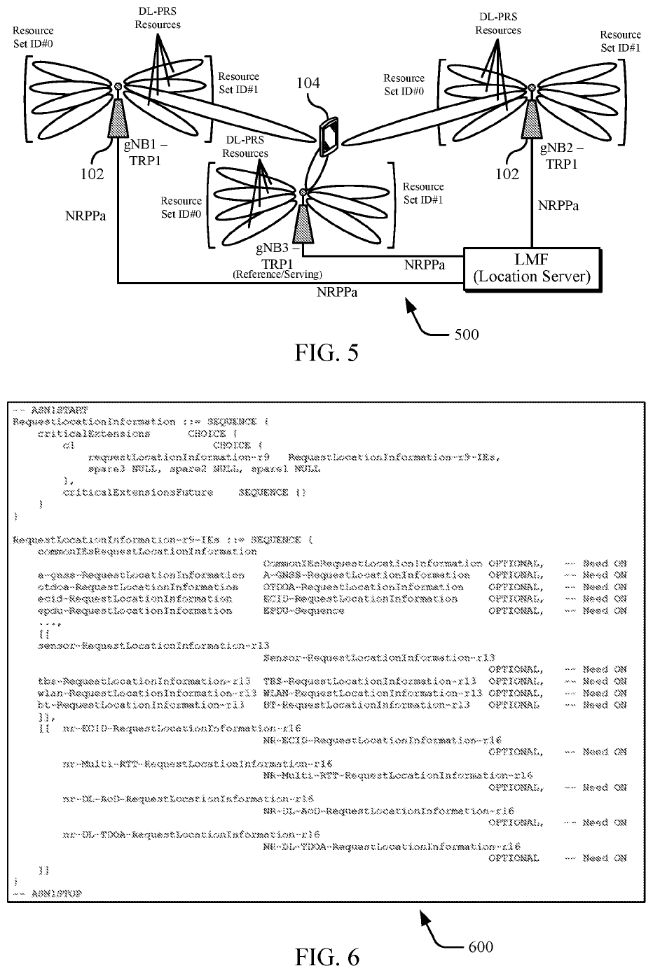

FIG. 5 illustrates an example of a system 500 of NR beam-based positioning as related to sidelink positioning reference signal processing in accordance with aspects of the present disclosure. The system 500 illustrates a UE 104 and base stations 102 (e.g., gNB). The PRS can be transmitted by different base stations (serving and neighboring) using narrow beams over FR1 and FR2 as illustrated in the example system 500, which is relatively different when compared to LTE where the PRS was transmitted across the whole cell. The PRS can be locally associated with a PRS Resource ID and Resource Set ID for a base station (TRP). Similarly, UE positioning measurements such as Reference Signal Time Difference (RSTD) and PRS RSRP measurements are made between beams (e.g., between a different pair of DL PRS resources or DL PRS resource sets) as opposed to different cells as was the case in LTE. In addition, there are additional UL positioning methods for the network to exploit in order to compute the target UE's location.

The Tables T2 and T3 show the reference signal to measurements mapping for each of the supported RAT-dependent positioning techniques at the UE and gNB, respectively.

TABLE T2
UE measurements to enable RAT-
dependent positioning techniques.

| | | To facilitate |
|---|---|---|
| | | support of the |
| DL/UL | | positioning |
| Reference Signals | UE Measurements | techniques |
| Rel. 16 DL PRS | DL RSTD | DL-TDOA |
| Rel. 16 DL PRS | DL PRS RSRP | DL-TDOA, DL- |
| | | AoD, Multi-RTT |
| Rel. 16 DL PRS/ | UE Rx − Tx time | Multi-RTT |
| Rel. 16 SRS for | difference | |
| positioning | | |
| Rel. 15 SSB/ | SS-RSRP(RSRP for RRM), | NR E-CID |
| CSI-RS for RRM | SS-RSRQ(for RRM), CSI- | |
| | RSRP (for RRM), CSI- | |
| | RSRQ (for RRM), SS- | |
| | RSRPB (for RRM) | |

TABLE T3
gNB measurements to enable RAT-dependent
positioning techniques.

| | | To facilitate |
|---|---|---|
| | | support of the |
| DL/UL | | positioning |
| Reference Signals | gNB Measurements | techniques |
| Rel. 16 SRS for | UL RTOA | UL-TDOA |
| positioning | | |
| Rel. 16 SRS for | UL SRS-REFERENCE | UL-TDOA, UL- |
| positioning | SIGNAL RECEIVED | AoA, Multi-RTT |
| | POWER (RSRP) | |
| Rel. 16 SRS for | gNB Rx − Tx time | Multi-RTT |
| positioning, Rel. | difference | |
| 16 DL PRS | | |
| Rel. 16 SRS for | AoA and ZoA | UL-AoA, |
| positioning | | Multi-RTT |

The RAT-dependent positioning techniques may utilize the 3GPP RAT and core network entities to perform the position estimation of the UE, which are differentiated from RAT-independent positioning techniques, which rely on GNSS, IMU sensor, WLAN, and Bluetooth technologies for performing target device (UE) positioning. Network-assisted GNSS methods make use of UEs that are equipped with radio receivers capable of receiving GNSS signals. In 3GPP specifications the term GNSS encompasses both global and regional/augmentation navigation satellite systems. Examples of global navigation satellite systems include GPS, Modernized GPS, Galileo, GLONASS, and BeiDou Navigation Satellite System (BDS). Regional navigation satellite systems include Quasi Zenith Satellite System (QZSS) while the many augmentation systems, are classified under the generic term of Space Based Augmentation Systems (SBAS) and provide regional augmentation services. Different GNSSs (e.g. GPS, Galileo, etc.) can be used separately or in combination to determine the location of a UE.

Barometric pressure sensor positioning makes use of barometric sensors to determine the vertical component of the position of the UE. The UE measures barometric pressure, optionally aided by assistance data, to calculate the vertical component of its location or to send measurements to the positioning server for position calculation. This method can be combined with other positioning methods to determine the 3D position of the UE. WLAN positioning makes use of the WLAN measurements (access point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Additionally or alternatively, the UE makes use of WLAN measurements and optionally WLAN AP assistance data provided by the positioning server, to determine its location.

Bluetooth positioning makes use of Bluetooth measurements (beacon identifiers and optionally other measurements) to determine the location of the UE. The UE measures received signals from Bluetooth beacons. Using the measurement results and a references database, the location of the UE 104 is calculated. The Bluetooth methods may be combined with other positioning methods (e.g., WLAN) to improve positioning accuracy of the UE. TBS positioning consists of a network of ground-based transmitters, broadcasting signals only for positioning purposes. The current type of TBS positioning signals are the MBS (Metropolitan Beacon System) signals and Positioning Reference Signals (PRS). The UE measures received TBS signals, optionally aided by assistance data, to calculate its location or to send measurements to the positioning server for position calculation. Motion sensor positioning makes use of different sensors such as accelerometers, gyros, magnetometers, to calculate the displacement of UE 104. The UE 104 estimates a relative displacement based upon a reference position and/or reference time. The UE 104 sends a report comprising the determined relative displacement which can be used to determine the absolute position. This method can be used with other positioning methods for hybrid positioning.

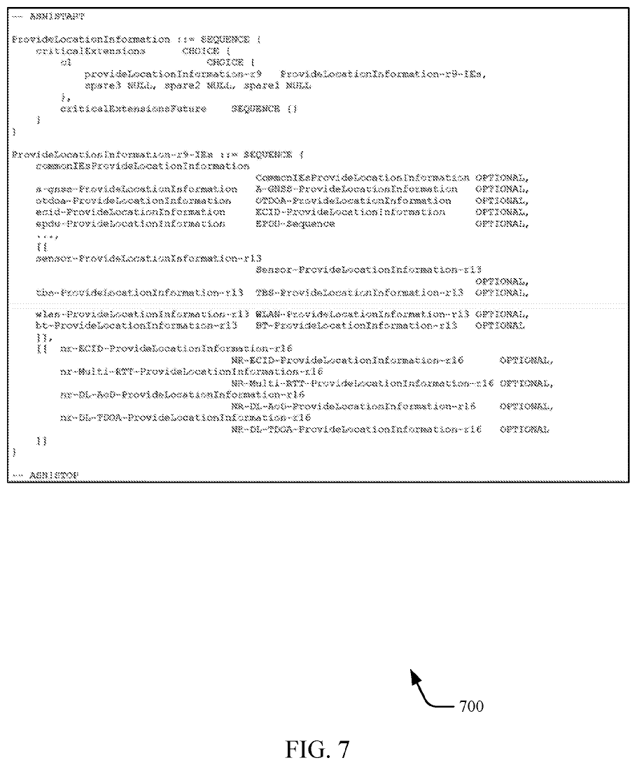

With reference to a conceptual overview of the current Uu implementation (release 16), the overall measurement configuration and reporting is performed per configured RAT-dependent positioning method and/or RAT-independent positioning method. FIG. 6 illustrates an example 600 of a LPP request location information (RequestLocationInformation) message as related to sidelink positioning measurement procedures, as described herein. The RequestLocationInformation message body in a LPP message is used by the location server to request positioning measurements or a position estimate from the target device. FIG. 7 illustrates an example 700 of a LPP provide location information (ProvideLocationInformation) message as related to sidelink positioning measurement procedures, as described herein. The ProvideLocationInformation message body in a LPP message is used by the target device to provide positioning measurements or position estimates to the location server.

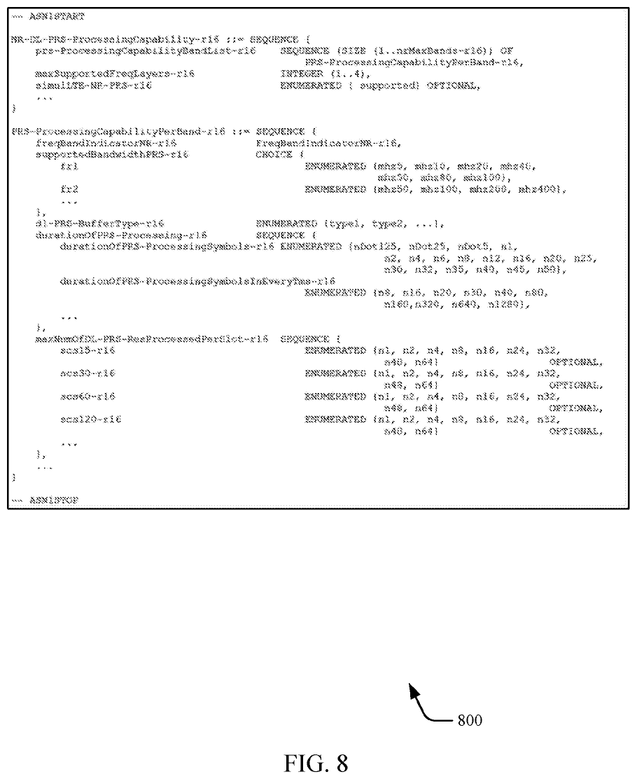

FIG. 8 illustrates an example 800 of NR-DL-PRS processing capability with reference to Uu PRS processing capability as related to sidelink positioning measurement procedures, as described herein. The IE NR-DL-PRS-ProcessingCapability defines the common DL-PRS processing capability. The capabilities for multiple NR positioning methods are provided, where the IE NR-DL-PRS-ProcessingCapability applies across the NR positioning methods and the target device shall indicate the same values for the capabilities in IEs NR-DL-TDOA-ProvideCapabilities, NR-DL-AoD-ProvideCapabilities, and NR-Multi-RTT-ProvideCapabilities. The PRS-ProcessingCapabilityPerBand is defined for a single positioning frequency layer on a certain band (i.e., a target device supporting multiple positioning frequency layers is expected to process one frequency layer at a time). The NR-DL-PRS-ProcessingCapability field descriptions are listed in Table T4.

TABLE T4
NR-DL-PRS-ProcessingCapability Field Descriptions
NR-DL-PRS-ProcessingCapability field descriptions

maxSupportedFreqLayers
Indicates the maximum number of positioning frequency layers
supported by UE.
supportedBandwidthPRS
Indicates the maximum number of DL-PRS bandwidth in MHz, which
is supported and reported by UE.
dl-PRS-BufferType
Indicates DL-PRS buffering capability. Value type1 indicates
sub-slot/symbol level buffering and value type2 indicates slot
level buffering.
durationOfPRS-Processing
Indicates the duration N of DL-PRS symbols in units of ms a UE
can process every T ms assuming maximum DL-PRS bandwidth provided
in supportedBandwidthPRS and comprises the following subfields:
durationOfPRS-ProcessingSymbols: This field specifies the values for
N. Enumerated values indicate 0.125, 0.25, 0.5, 1, 2, 4, 8, 12, 16,
20, 25, 30, 35, 40, 45, 50 ms.
durationOfPRS-ProcessingSymbolsInEveryTms: This field specifies
the values for T. Enumerated values indicate 8, 16, 20, 30, 40,
80, 160, 320, 640, 1280 ms.
See NOTE.
maxNumOfDL-PRS-ResProcessedPerSlot
Indicates the maximum number of DL-PRS resources that UE can process
in a slot. SCS: 15 kHz, 30 kHz, 60 kHz are applicable for FR1 bands.
SCS: 60 kHz, 120 kHz are applicable for FR2 bands.
simulLTE-NR-PRS
Indicates whether the UE supports parallel processing of LTE PRS
and NR PRS.
NOTE:
When the target device (UE) provides the durationOfPRS-Processing capability (N, T) for any P(≥T) time window (i.e., defined in TS 38.214 [45] clause 5.1.6.5), the target device should be capable of processing all DL-PRS resources within P, in N ≥ K (where K is also defined in TS 38.214 [45] clause 5.1.6.5), and the number of DL-PRS resources in each slot does not exceed the maxNumOfDL-PRS-ResProcessedPerSlot, and the configured measurement gap and a maximum ratio of measurement gap length (MGL) and measurement gap repetition period (MGRP) is as specified (i.e., in TS 38.133 [46]).

In aspects of this disclosure, Uu PRS processing is taken into consideration. Several options are supported subject to UE capability for priority handling of PRS when PRS measurement is outside of MG. In a first option (Option 1), a UE may indicate support of two priority states. In state 1, PRS is higher priority than all PDCCH/PDSCH/CSI-RS, and in state 2, PRS is lower priority than all PDCCH/PDSCH/CSI-RS. In a second option (Option 2), a UE may indicate support of three priority states. In state 1, PRS is higher priority than all PDCCH/PDSCH/CSI-RS, and in state 2, PRS is lower priority than PDCCH and URLLC PDSCH and higher priority than other PDSCH/CSI-RS. Note that the URLLC channel corresponds a dynamically scheduled PDSCH whose PUCCH resource for carrying ACK/NAK is marked as high-priority. In state 3, PRS is lower priority than all PDCCH/PDSCH/CSI-RS. In a third option (Option 3), a UE may indicate support of single priority state, where in state 1, PRS is higher priority than all PDCCH/PDSCH/CSI-RS (Note that SSB is a separate issue).

For the purpose of determining conditions for measuring the PRS outside of a MG, the expected Rx timing difference between the PRS from the non-serving cell and that from the serving cell is determined by expected RSTD and expected RSTD uncertainty in the assistance data. An LS can be sent to request RAN4 study and determine the threshold, which can be compared against the Rx timing difference to determine whether the PRS from the non-serving cell satisfies the condition of PRS measurement outside MG. Examples for the threshold include CP length, 50% of the OFDM symbol, and 1 ms. Other options can also be considered by RAN4, and note the requirement on whether a UE needs to calculate the expected Rx time difference and/or compare against the threshold is also a part of the study request.

In aspects, the following parameters for PRS processing window from the gNB to the UE are supported, and include at least starting slot, periodicity, duration/length, and cell and SCS information associated with the above parameters. During the maintenance phase, the necessity of other parameters to discuss include, but are not limited to processing type (associated with the corresponding UE capability 1A/1B/2), band/CC-ID as needed depending on each scenario on which the PRS processing window is applied, and the above cell and SCS information to determine where and when the PRS processing window is applied. Note that an indication of processing type does not suggest UE indication of multiple capabilities among (1A/1B/2) is already supported, which is a separate discussion. Further, some of the parameters may not be mandatory for a PRS processing window. The priority of PRS for UE supporting two priority states and three priority states can at least be indicated in RRC.

For capability 1A, as per the working assumption made in RAN1 #106-e, the DL signaling and/or channels in a per UE fashion (i.e. both across NR & LTE) inside the PRS processing window are dropped if the DL PRS is determined to be higher priority. For capability 1B, as per the working assumption made in RAN1 #106-e, only the DL signaling and/or channels from a certain band inside the PRS processing window are dropped if the DL PRS is determined to be higher priority. In the working assumption, subject to UE capability, support PRS measurement outside the MG, within a PRS processing window, and UE measurement inside the active DL BWP with PRS having the same numerology as the active DL BWP. Inside the PRS processing window, subject to the UE determining that DL PRS is to be higher priority, the following UE capabilities are supported. A capability 1 for PRS prioritization over all other DL signals and channels in all symbols inside the window, (Cap. 1A) the DL signals and channels from all DL CCs (per UE) are affected, and (Cap. 1B) only the DL signals and channels from a certain band or CC are affected (where FFS is band or CC). A capability 2 for PRS prioritization over other DL signals and channels only in the PRS symbols inside the window, a UE shall be able to declare a PRS processing capability outside MG. For FFS, details of capability signaling (e.g., per UE or per band, etc.).

A PRS processing window request to the gNB by the LMF is supported from RAN1 perspective. It is up to RAN3 to design the necessary information to be transferred in the NRPPa message. Note that it is up to gNB to determine the usage of measurement gap or PRS processing window, and include it in the LS to RAN2 and RAN3. For PRS processing window configuration and indication, at least the following mechanism is supported: RRC (pre-) configuration for PRS processing window configuration and DL MAC CE activation for PRS processing window, respectively; and include it in the LS to RAN2 and request RAN2 to decide whether DL AC CE is feasible for this indication.

With reference to RAT-dependent positioning measurements, the different downlink measurements, including DL PRS RSRP, downlink RSTD, and UE Rx-Tx time difference required for the supported RAT-dependent positioning techniques are shown in Table T5. The measurement configurations may include four (4) pair of downlink RSTD measurements performed per pair of cells, and each measurement is performed between a different pair of downlink PRS resources or resource sets with a single reference timing; and eight (8) downlink PRS reference signal received power (RSRP) measurements can be performed on different downlink PRS resources from the same cell.

TABLE T5
Downlink measurements for downlink-based positioning techniques.
DL PRS reference signal received power (DL PRS-RSRP)

| | |
|---|---|
| Definition | DL PRS-RSRP, is the linear average over the power contributions (in [W]) of |
| | the resource elements that carry DL PRS reference signals configured for |
| | RSRP measurements within the considered measurement frequency |
| | bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than |
| | the corresponding DL PRS-RSRP of any of the individual receiver branches. |
| Applicable | RRC_CONNECTED intra-frequency, |
| for | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe |
| | received from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for |
| | the DL RSTD shall be the antenna of the UE. |
| Applicable | RRC_CONNECTED intra-frequency |
| for | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement shall be the |
| | Rx antenna connector of the UE and the reference point for T_{UE-TX} |
| | measurement shall be the Tx antenna connector of the UE. For frequency |
| | range 2, the reference point for T_{UE-RX} measurement shall be the Rx antenna of |
| | the UE and the reference point for T_{UE-TX} measurement shall be the Tx antenna |
| | of the UE. |
| Applicable | RRC_CONNECTED intra-frequency |
| for | RRC_CONNECTED inter-frequency |

Aspects of the present disclosure support the processing functionality of sidelink reference signals in a standalone manner and with respect to other sidelink signals and/or channels. This disclosure details several implementations supporting sidelink (PC5) varying sidelink PRS positioning processing capabilities. Given the wide range of hardware requirements and UE capabilities, different UEs may support different sidelink PRS processing capabilities. Aspects of the disclosure include implementations to define the sidelink PRS processing behaviour for UEs, such as for performing on sidelink positioning measurement and processing, and performing joint SL and Uu measurement and processing, including coordination of measurement gap with sidelink PRS occasion. Additionally, the disclosure includes an implementation to request and report sidelink positioning processing capabilities for performing sidelink positioning including the number of sidelink PRS symbols in a given duration. The described aspects also provide for a centralized and decentralized sidelink prioritization processing window configuration, in which to process sidelink PRS with respect to other signals and/or channels. Further, the described aspects provide to perform sidelink PRS processing capability exchange in a variety of different coverage scenarios including in-coverage, partial coverage, and out-of-coverage.

In terms of the described techniques, an initiator device initiates a sidelink positioning and ranging session, and a responder device responds to the sidelink positioning and ranging session from the initiator device. Further, the described implementations for sidelink positioning reference signal processing may be implemented in combination to support NR RAT-independent positioning over the sidelink (PC5) interface. In this disclosure, a positioning-related reference signal may be referred to as a reference signal used for positioning procedures and/or purposes in order to estimate a target-UE's location, such as based on positioning reference signals (PRS), or based on existing reference signals, such as a channel state information reference signal (CSI-RS) or a sounding reference signal (SRS). A target-UE may be referred to as the device or network entity to be localized or positioned. In implementations, the term PRS can refer to any signal, such as a reference signal, which may or may not be used primarily for positioning. A target-UE may also be referred to as a UE of interest, having a position (absolute or relative) that is to be obtained by the network or by the UE itself. Notably, any aspects of the positioning techniques described in this disclosure may be implemented in combination with any additional aspects of the positioning techniques described in the related disclosure: U.S. Patent Application No. 63/307,453 entitled “Sidelink Positioning Measurement Procedures” filed Feb. 7, 2022 (docket no. SMM920210192-US-PSPF).

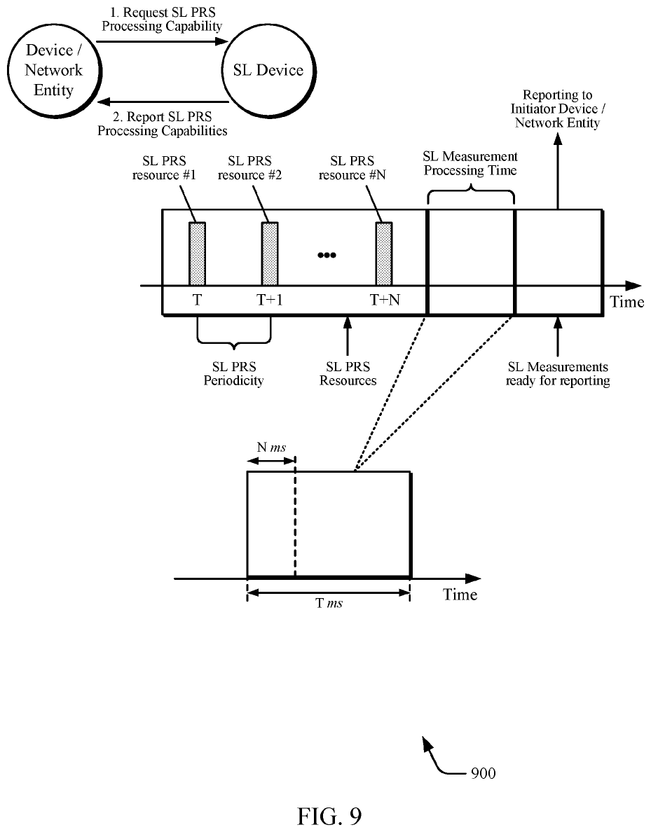

FIG. 9 illustrates an example 900 of sidelink PRS processing capabilities for processing sidelink PRS resources that supports sidelink positioning reference signal processing in accordance with aspects of the present disclosure. A sidelink capable device may report its processing capabilities related to PRS processing based on a solicited or unsolicited request from a network entity (e.g., a UE or other network device). In an implementation, the network devices an UEs may receive information regarding the sidelink PRS processing capabilities of the UEs, devices, anchor nodes, and/or reference devices and UEs. Based on the reported sidelink PRS processing options supported at the UE, the configuration entity (e.g., base station, UE, location server) may select and indicate sidelink PRS configuration for measurement according to the UE capability and the required latency for the corresponding positioning session. The UE may indicate to the network or other UEs, an absolute time duration or a duration of sidelink PRS symbols N in units of ms that it may process every T ms, assuming a maximum sidelink PRS bandwidth. The type of capabilities can affect the amount of sidelink PRS resources a UE can process in a given time, as well as the latency of processing the sidelink PRS. The configuration entity may then configure a set of sidelink PRS resources based on the sidelink PRS processing capabilities of the UE.

Further, the UE may also indicate the amount of sidelink PRS resources that it can process in a time unit, for example a sidelink slot, a sidelink symbol depending on the sub carrier spacing (SCS). In another implementation, the UE may indicate the required number of sidelink slots and/or sidelink symbols for different measurement methods (e.g. TDOA, AoA, AoD, ranging, etc.) if the measurement method is not indicated in the PRS processing capability request. The example 900 illustrates the concept of processing sidelink PRS resources, and shows that the sidelink UE may buffer N symbols of sidelink PRS in T amount of time. For optimized processing, the duration (N-T) should be kept as short as possible, which can vary depending on the hardware capabilities of the UE. In another implementation, when the required number of sidelink PRS resources cannot be processed at the UE (for example due to ongoing processing), then the processing can be either postponed or dropped. In another implementation, the ongoing processing can be dropped to make resources available. The dropping and/or postponement of processing can be associated to different priority levels, as further described below. In an implementation, the network device or entity provides, in the PRS processing capability request, the latency requirement that the UE needs to fulfil to process and report back the measurement. The UE may report a single bit of information whether it is capable to satisfy the latency requirement or not.

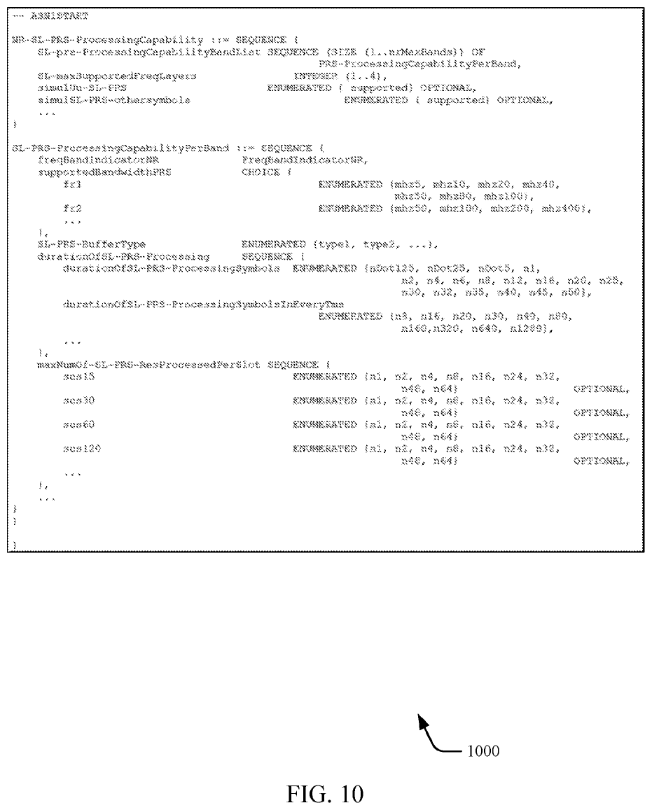

FIG. 10 illustrates an example 1000 of the NR-SL-PRS-ProcessingCapability message that supports sidelink positioning reference signal processing in accordance with aspects of the present disclosure. In an implementation, the sidelink UE or other device may report the maximum number of sidelink positioning frequency layers (PFL), the supported sidelink PRS bandwidths, the buffer type, supported durations of sidelink PRS processing, supported maximum number of sidelink PRS resources in a slot, an indication whether the UE may support parallel processing of SL PRS and Uu PRS, and/or an indication as to whether the UE may support parallel processing of sidelink PRS and other sidelink channels or signals. The sidelink and Uu positioning frequency layers may be fully or partially overlapping. The sidelink PFL is a collection of sidelink PRS resources across time-frequency with the same SCS and CP type, the same center frequency, the same point-A, and configured bandwidth (including same start reference time, e.g., start physical resource block). The example 1000 illustrates an example signaling extract to define sidelink PRS processing capabilities of a UE. This configuration may be signaled via assistance data (or any other sidelink positioning resource configuration signaling) and/or measurement configuration for sidelink positioning.

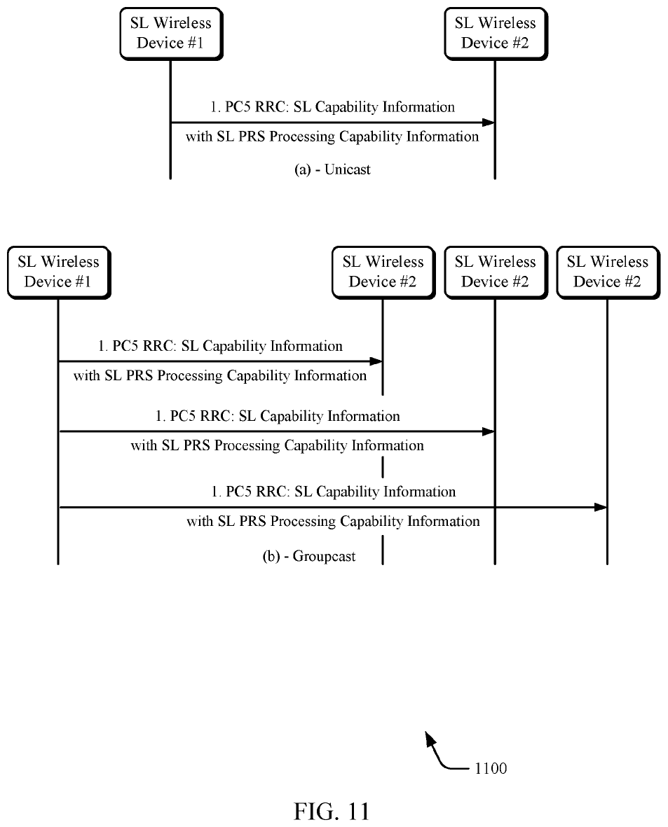

FIG. 11 illustrates an example 1100 of unicast and groupcast signaling for unsolicited sidelink PRS processing capability message transfer that supports sidelink positioning reference signal processing in accordance with aspects of the present disclosure. The request for sidelink processing capabilities may be signaled using either broadcast signaling (e.g., via groupcast messages, positioning SIBs, V2X SIBs, or the like), or by dedicated signaling (e.g., PC5 RRC, RRC, MAC CE, LPP signaling). In an example implementation, the sidelink processing capabilities between sidelink UEs participating in a unicast or groupcast session may be signaled via capability information PC5 RRC signaling (unsolicited), or via request as capability inquiry and capability information request. The example 1100 illustrates an example of a unicast and groupcast unsolicited capability information transfer containing the sidelink PRS processing capabilities between a pair of UEs, and between a UE and set of member UEs belonging to the same group. In another implementation, an initiator UE or network device (e.g., configuring device) may request the responder UE for the joint Uu and sidelink processing capabilities depending on the UE's support for Uu and/or sidelink positioning. In general, the positioning calculation entity may require the knowledge of both the Uu and SL positioning capabilities of a UE depending on whether the absolute and/or relative location information is required.

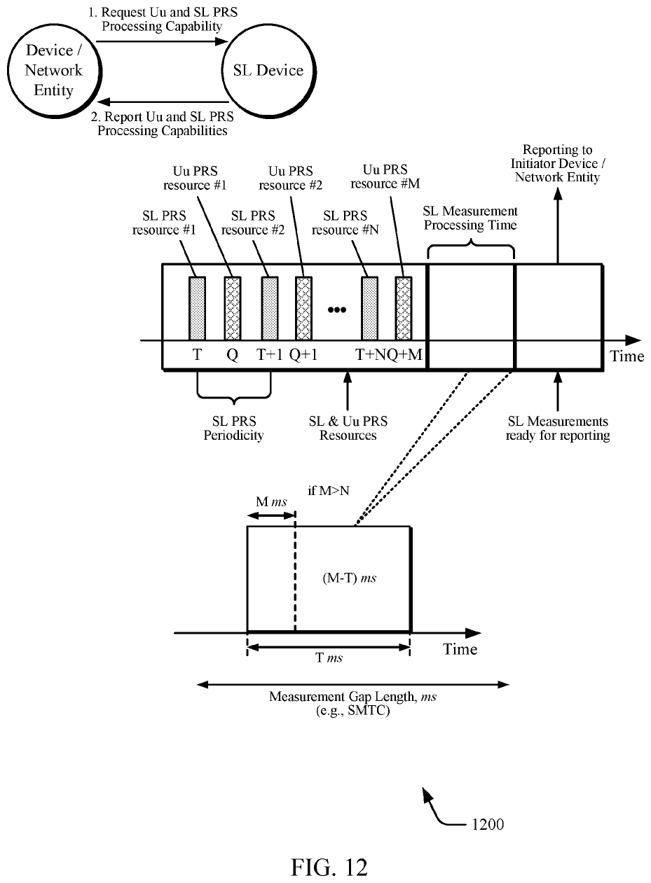

FIG. 12 illustrates an example 1200 of joint Uu and SL PRS processing capabilities for processing Uu and SL PRS resources that supports sidelink positioning reference signal processing in accordance with aspects of the present disclosure. In an implementation, the UE or network device supporting both legacy LPP positioning (Uu positioning) and sidelink positioning can perform joint PRS processing depending on the time instance in which both the Uu and SL measurements are available for measurement and processing. In the context of Uu positioning, the measurements can also be performed with or without a measurement gap. Therefore, the joint processing of sidelink and Uu PRS may also be considered in the case of gapless measurement. In addition, the configuration entity may then configure a set of Uu and SL PRS resources based on both Uu and SL PRS processing capabilities of the UE.

The example 1200 illustrates the concept of processing joint Uu and SL PRS resources within a measurement gap. FIG. 9 also shows that the sidelink UE may buffer N symbols of sidelink PRS and M symbols of Uu PRS in T amount of time. For optimized processing, the duration (M−T) should be kept as short as possible, which can vary depending on the hardware capabilities of the UE. In addition, the amount of SL and Uu PRS symbols in a duration T should fall within the measurement gap length (e.g. based on existing values such as 20 ms, etc.). The number of symbols to be buffered may depend on the duration of the largest number of symbols to be processed within the set (N,M), e.g. if M>N, then the buffer period is set to M ms and the corresponding processing time is set to (M−T) ms.

In another implementation, a separate sidelink measurement occasion may be defined in which to perform sidelink positioning measurements or joint Uu and SL measurements, similar to a measurement gap with a start time, length, repetition period, and offset. The processing would be performed when the measurement gaps and sidelink measurement occasions are overlapping. In addition, such a sidelink positioning measurement occasion may be configured via one of several signal delivery mechanisms, including RRC, MAC CE, LPP, PC5 RRC, and/or PC5-S. In other implementations, the sidelink positioning measurement occasion may be pre-configured. Multiple sidelink measurement occasions may be configured with varying lengths and repetition periods within a resource pool.

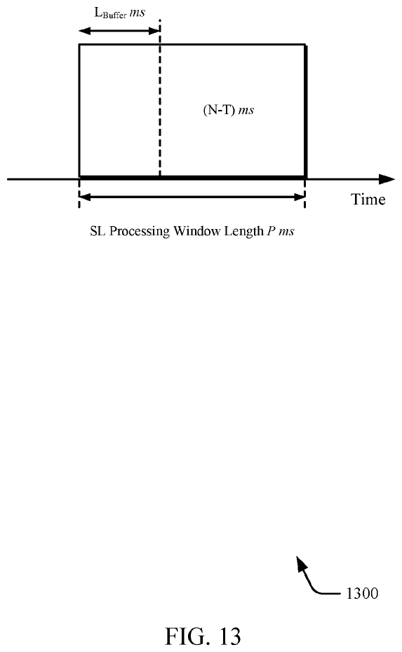

FIG. 13 illustrates an example 1300 of a sidelink prioritization processing window that supports sidelink positioning reference signal processing in accordance with aspects of the present disclosure. In implementations, different types of processing capabilities may be defined to deal with the prioritization of sidelink PRS with respect to sidelink data transmissions and other reference signals. (e.g., transmitted on PSSCH). A configuration entity may configure a time duration in which sidelink PRS may have a defined priority indication with respect to other sidelink channels and signals, including data transmissions. This time duration may be a window or timeline with a pre-defined start time, duration or length, end time (where applicable), and/or periodicity or repetition period. The prioritization window may be determined differently for Mode 1 and Mode 2 sidelink operations.

Procedures can be implemented in which a prioritization processing window is configured for UEs in-coverage and partial coverage scenarios. In Mode 1, a base station (e.g., gNB) provides the resource pool configuration for Mode 1 sidelink transmissions, while the initiator UE (e.g., Tx UE) may also configure the processing window depending on whether a particular sidelink transmission (i.e., a sidelink data, or sidelink PRS) may be prioritized. An aspect of the prioritization window in sidelink is to define a framework of prioritization, wherein sidelink PRS may or may not be prioritized with respect to other sidelink data and signals. This may be defined via a separate capability in the specification. By defining this processing window, defined sidelink PRS that may fall outside this window may be dropped in favor of other sidelink data and/or signals, while sidelink PRS falling within this prioritization processing window have the following priority states: a priority state 1, in which sidelink PRS has a higher priority than other sidelink data or channels, and a priority state 2, in which sidelink PRS has a lower priority than other sidelink data or channels.

In other implementations, the sidelink PRS may have one priority state, where sidelink PRS has a higher priority than all signals received within the prioritization window. The sidelink channels may include PSCCH, PSSCH, PBCH, PSFCH, and sidelink signals may include S-SSB, S-PSS, S-SSS, SL DMRS, SL CSI-RS, SL PT-RS or the like. Contrary to the buffering and processing time described above, the prioritization processing window can enable a flexible buffering length of sidelink PRS and other sidelink signals or channels depending on the length of the window and (N,T) sidelink capabilities of the UE. The example 1300 illustrates a priority processing window for sidelink.

In aspects of the disclosure, a prioritization processing window can be configured for in-coverage and partial coverage scenarios. The UE or network devices performing the positioning perform resource allocation in a distributed manner, and therefore depending on the sensing and selection procedures, a prioritization processing window may be configured via system information signaling and/or a pre-configuration. In the case of Mode 2, the prioritization processing window may consist of a set of priority rules, which may be pre-configured in the UE. These priority rules may also be updated on an on-demand basis using dynamic signaling or using system information elements. In the case of a unicast positioning session, the sidelink PRS prioritization window may be configured in a UE-specific manner. In the case of groupcast positioning, a common sidelink PRS prioritization window can be configured to member UEs, while in other implementations, each member UE may be configured with a separate sidelink PRS prioritization window.

The processing configuration and capabilities exchange can be supported in several implementation scenarios. In a first scenario for UE-based, UE-configured processing configuration and capabilities exchange, a UE supporting sidelink positioning performs and processes sidelink PRS measurements based on a processing configuration provided by another UE or device (e.g., an anchor UE, a reference UE, target-UEs, a roadside unit, or the like). In this scenario, the absolute and/or relative positioning calculation entity may be the UE performing and processing the sidelink measurements based on a provided sidelink PRS prioritization processing window configuration. Alternatively, the prioritization processing window configuration may be based on a pre-configuration and/or system information from a previously visited cell or RAN notification area. In addition, the processing capabilities are requested by UEs or other devices and shared with other UEs and devices participating in a sidelink positioning session.

In a second scenario for UE-based network configured processing configuration and capabilities exchange, a UE supporting sidelink positioning performs and processes sidelink PRS measurements based on a processing configuration provided by one or more network entities, such as a base station (e.g., gNB), a location server, a reference station, a reference TRP, roadside units, via positioning assistance data, or measurement configuration signaling. In this scenario, the absolute and/or relative positioning calculation entity may be the UE performing and processing the sidelink PRS measurements based on the provided sidelink PRS prioritization processing window configuration.

In a third scenario for UE-assisted UE-configured processing configuration and capabilities exchange, a UE supporting sidelink positioning performs and processes sidelink PRS measurements based on a processing configuration provided by another UE or device (e.g., an anchor UE, a reference UE, target-UEs, or the like). In this scenario, the absolute and/or relative positioning calculation entity may be a network entity may be performing and processing the sidelink measurements based on the provided sidelink PRS prioritization processing window configuration from a base station (e.g., gNB), a location server, a reference station, a reference TRP, and/or roadside units, and the like. Alternatively, the sidelink PRS prioritization processing window configuration may be based on a pre-configuration and/or system information from a previously visited cell or RAN notification area.

In a fourth scenario for UE-assisted network configured processing configuration and capabilities exchange, a UE supporting sidelink positioning performs and processes sidelink PRS measurements based on a processing configuration provided by one or more network entities, such as a base station (e.g., gNB), a location server, a reference station, a reference TRP, roadside units, via positioning assistance data, or measurement configuration signaling. In this scenario, the absolute and/or relative positioning calculation entity may be a network entity performing and processing the sidelink measurements based on the provided sidelink PRS prioritization processing window configuration from a base station (e.g., gNB), a location server, a reference station, a reference TRP, and/or roadside units, and the like.

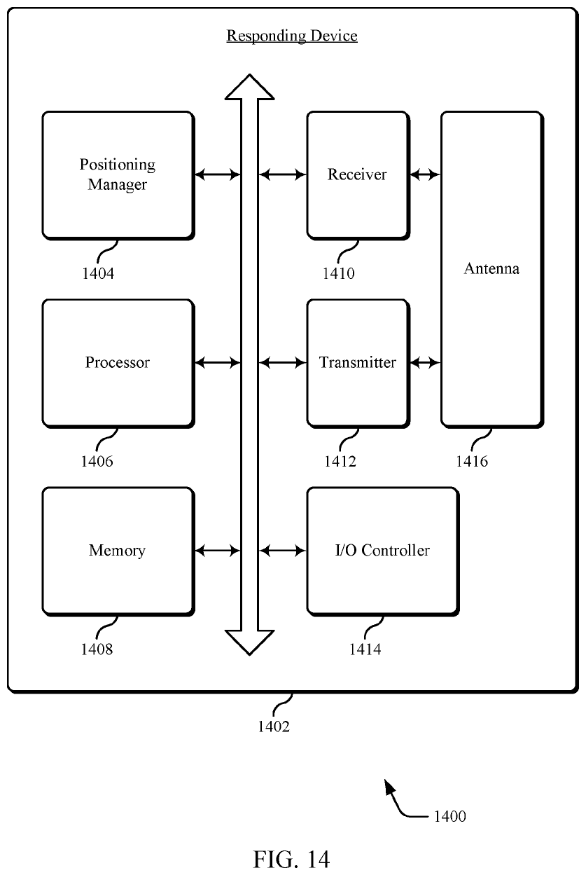

FIG. 14 illustrates an example of a block diagram 1400 of a device 1402 that supports sidelink positioning reference signal processing in accordance with aspects of the present disclosure. The device 1402 may be an example of a UE 104 such as a responding device, as described herein. The device 1402 may support wireless communication and/or network signaling with one or more base stations 102, other UEs 104, network entities and devices, or any combination thereof. The device 1402 may include components for bi-directional communications including components for transmitting and receiving communications, such as a positioning manager 1404, a processor 1406, a memory 1408, a receiver 1410, a transmitter 1412, and an I/O controller 1414. These components may be in electronic communication or otherwise coupled (e.g., operatively, communicatively, functionally, electronically, electrically) via one or more interfaces (e.g., buses).

The positioning manager 1404, the receiver 1410, the transmitter 1412, or various combinations thereof or various components thereof may be examples of means for performing various aspects of the present disclosure as described herein. For example, the positioning manager 1404, the receiver 1410, the transmitter 1412, or various combinations or components thereof may support a method for performing one or more of the functions described herein.

In some implementations, the positioning manager 1404, the receiver 1410, the transmitter 1412, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1406 and the memory 1408 coupled with the processor 1406 may be configured to perform one or more of the functions described herein (e.g., by executing, by the processor 1406, instructions stored in the memory 1408).

Additionally or alternatively, in some implementations, the positioning manager 1404, the receiver 1410, the transmitter 1412, or various combinations or components thereof may be implemented in code (e.g., as communications management software or firmware) executed by the processor 1406. If implemented in code executed by the processor 1406, the functions of the positioning manager 1404, the receiver 1410, the transmitter 1412, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the positioning manager 1404 may be configured to perform various operations (e.g., receiving, monitoring, transmitting) using or otherwise in cooperation with the receiver 1410, the transmitter 1412, or both. For example, the positioning manager 1404 may receive information from the receiver 1410, send information to the transmitter 1412, or be integrated in combination with the receiver 1410, the transmitter 1412, or both to receive information, transmit information, or perform various other operations as described herein. Although the positioning manager 1404 is illustrated as a separate component, in some implementations, one or more functions described with reference to the positioning manager 1404 may be supported by or performed by the processor 1406, the memory 1408, or any combination thereof. For example, the memory 1408 may store code, which may include instructions executable by the processor 1406 to cause the device 1402 to perform various aspects of the present disclosure as described herein, or the processor 1406 and the memory 1408 may be otherwise configured to perform or support such operations.

For example, the positioning manager 1404 may support wireless communication and/or network signaling at a device (e.g., the device 1402, a UE) in accordance with examples as disclosed herein. The positioning manager 1404 and/or other device components may be configured as or otherwise support an apparatus, such as a UE as a responding device, including a transceiver; a processor coupled to the transceiver, the processor and the transceiver configured to cause the apparatus to: receive a request message to indicate a sidelink positioning reference signal (PRS) processing capability of the apparatus; transmit a response message indicating the sidelink PRS processing capability of the apparatus based at least in part on the received request message; receive a sidelink PRS configuration indicating a respective duration and a respective priority associated with processing at least one sidelink PRS with respect to at least one additional sidelink signal; and process the at least one sidelink PRS based at least in part on the received sidelink PRS configuration.

Additionally, the apparatus (e.g., a UE as a responding device) includes any one or combination of: the apparatus comprises at least one of a roadside unit, a reference UE, an anchor UE, or one or more UE configured for sidelink PRS processing. The processor is configured to cause the apparatus to receive the request message to indicate a joint sidelink and Uu interface PRS processing capability of the apparatus, and transmit the response message indicating the joint sidelink and Uu interface PRS processing capability of the apparatus. The processor is configured to cause the apparatus to determine the joint sidelink and Uu interface PRS processing capability based at least in part on a number of one or more sidelink PRS symbols or Uu interface PRS symbols that the apparatus can jointly process and buffer during a configured slot duration. The processor is configured to cause the apparatus to jointly process sidelink PRS and Uu interface PRS in accordance with a Uu measurement gap configuration. The processor is configured to cause the apparatus to jointly process sidelink PRS and Uu interface PRS on overlapping or partially overlapping positioning frequency layers. The response message indicating the sidelink PRS processing capability includes information comprising sidelink PRS symbols that the apparatus can process according to the sidelink PRS configuration. The response message indicating the sidelink PRS processing capability includes information comprising an amount of sidelink PRS resources that the apparatus can be processed in a sidelink slot depending on a sidelink positioning frequency layer. The sidelink PRS configuration comprises criteria of sidelink PRS prioritization as at least one of a first priority state of the sidelink PRS processing having a higher priority than the at least one sidelink PRS data processing, or a second priority state of the sidelink PRS processing having a lower priority than the at least one sidelink PRS data processing. The at least one additional sidelink signal includes at least one of PSCCH, PSSCH, PBCH, or PSFCH communicated over a sidelink channel as at least one of S-SSB, S-PSS, S-SSS, SL DMRS, SL CSI-RS, or SL PT-RS. The response message indicating the sidelink PRS processing capability of the apparatus includes one or more of a maximum number of sidelink positioning frequency layers, supported sidelink PRS bandwidths, a buffer type, supported durations of PRS processing, a supported maximum number of sidelink PRS resources in a slot, an indication as to whether the apparatus supports parallel processing of sidelink PRS and Uu PRS, or an indication as to whether the apparatus supports parallel processing of sidelink PRS and the at least one additional sidelink signal. The joint sidelink and Uu interface PRS processing capability is based at least in part on a duration of a largest number of symbols to be processed within a set of sidelink and Uu PRS symbols to be jointly processed. A separate sidelink measurement occasion is defined during which to perform the sidelink PRS positioning measurements or the joint sidelink and Uu PRS measurements according to a measurement gap having a start time, a length, a repetition period, and an offset. The separate sidelink measurement occasion is configured via a signaling mechanism comprising at least one of RRC, MAC CE, LPP, PC5 RRC, or PC5-S. A flexible buffer length is configured for joint processing the sidelink PRS and the at least one additional sidelink signal. The sidelink PRS configuration is configured for Mode 1 and Mode 2 sidelink communications.

The positioning manager 1404 and/or other device components may be configured as or otherwise support a means for wireless communication and/or network signaling at a UE as a responding device, including receiving a request message to indicate a sidelink positioning reference signal (PRS) processing capability; transmitting a response message indicating the sidelink PRS processing capability based at least in part on the received request message; receiving a sidelink PRS configuration indicating a respective duration and a respective priority associated with processing at least one sidelink PRS with respect to at least one additional sidelink signal; and processing the at least one sidelink PRS based at least in part on the received sidelink PRS configuration.

Additionally, wireless communication and/or network signaling at the UE includes any one or combination of: receiving the request message to indicate a joint sidelink and Uu interface PRS processing capability, and transmitting the response message indicating the joint sidelink and Uu interface PRS processing capability. The method further comprising determining the joint sidelink and Uu interface PRS processing capability based at least in part on a number of one or more sidelink PRS symbols or Uu interface PRS symbols that can be jointly processed and buffered during a configured slot duration. The method further comprising jointly processing sidelink PRS and Uu interface PRS in accordance with a Uu measurement gap configuration. The sidelink PRS configuration comprises criteria of sidelink PRS prioritization as at least one of a first priority state of the sidelink PRS processing having a higher priority than the at least one sidelink PRS data processing, or a second priority state of the sidelink PRS processing having a lower priority than the at least one sidelink PRS data processing. The response message indicating the sidelink PRS processing capability includes information comprising sidelink PRS symbols that can process according to the sidelink PRS configuration. The response message indicating the sidelink PRS processing capability includes information comprising an amount of sidelink PRS resources that can be processed in a sidelink slot depending on a sidelink positioning frequency layer. The method further comprising jointly processing sidelink PRS and Uu interface PRS on overlapping or partially overlapping frequency layers.

The processor 1406 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1406 may be configured to operate a memory array using a memory controller. In some other implementations, a memory controller may be integrated into the processor 1406. The processor 1406 may be configured to execute computer-readable instructions stored in a memory (e.g., the memory 1408) to cause the device 1402 to perform various functions of the present disclosure.

The memory 1408 may include random access memory (RAM) and read-only memory (ROM). The memory 1408 may store computer-readable, computer-executable code including instructions that, when executed by the processor 1406 cause the device 1402 to perform various functions described herein. The code may be stored in a non-transitory computer-readable medium such as system memory or another type of memory. In some implementations, the code may not be directly executable by the processor 1406 but may cause a computer (e.g., when compiled and executed) to perform functions described herein. In some implementations, the memory 1408 may include, among other things, a basic I/O system (BIOS) which may control basic hardware or software operation such as the interaction with peripheral components or devices.

The I/O controller 1414 may manage input and output signals for the device 1402. The I/O controller 1414 may also manage peripherals not integrated into the device 1402. In some implementations, the I/O controller 1414 may represent a physical connection or port to an external peripheral. In some implementations, the I/O controller 1414 may utilize an operating system such as iOS®, ANDROID®, MS-DOS®, MS-WINDOWS®, OS/2®, UNIX®, LINUX®, or another known operating system. In some implementations, the I/O controller 1414 may be implemented as part of a processor, such as the processor 1406. In some implementations, a user may interact with the device 1402 via the I/O controller 1414 or via hardware components controlled by the I/O controller 1414.

In some implementations, the device 1402 may include a single antenna 1416. However, in some other implementations, the device 1402 may have more than one antenna 1416, which may be capable of concurrently transmitting or receiving multiple wireless transmissions. The receiver 1410 and the transmitter 1412 may communicate bi-directionally, via the one or more antennas 1416, wired, or wireless links as described herein. For example, the receiver 1410 and the transmitter 1412 may represent a wireless transceiver and may communicate bi-directionally with another wireless transceiver. The transceiver may also include a modem to modulate the packets, to provide the modulated packets to one or more antennas 1416 for transmission, and to demodulate packets received from the one or more antennas 1416.

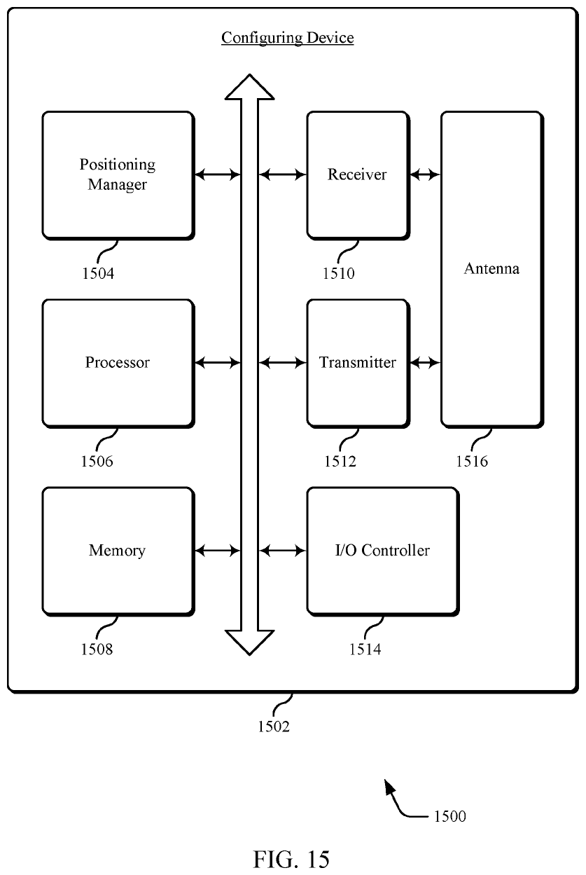

FIG. 15 illustrates an example of a block diagram 1500 of a device 1502 that supports sidelink positioning reference signal processing in accordance with aspects of the present disclosure. The device 1502 may be an example of a sidelink enabled device as a network entity and configuring device, as described herein. The device 1502 may support wireless communication and/or network signaling with one or more base stations 102, other UEs 104, core network devices and functions (e.g., core network 106), network entities and devices, or any combination thereof. The device 1502 may include components for bi-directional communications including components for transmitting and receiving communications, such as a positioning manager 1504, a processor 1506, a memory 1508, a receiver 1510, a transmitter 1512, and an I/O controller 1514. These components may be in electronic communication or otherwise coupled (e.g., operatively, communicatively, functionally, electronically, electrically) via one or more interfaces (e.g., buses).

The positioning manager 1504, the receiver 1510, the transmitter 1512, or various combinations thereof or various components thereof may be examples of means for performing various aspects of the present disclosure as described herein. For example, the positioning manager 1504, the receiver 1510, the transmitter 1512, or various combinations or components thereof may support a method for performing one or more of the functions described herein.

In some implementations, the positioning manager 1504, the receiver 1510, the transmitter 1512, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1506 and the memory 1508 coupled with the processor 1506 may be configured to perform one or more of the functions described herein (e.g., by executing, by the processor 1506, instructions stored in the memory 1508).

Additionally or alternatively, in some implementations, the positioning manager 1504, the receiver 1510, the transmitter 1512, or various combinations or components thereof may be implemented in code (e.g., as communications management software or firmware) executed by the processor 1506. If implemented in code executed by the processor 1506, the functions of the positioning manager 1504, the receiver 1510, the transmitter 1512, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the positioning manager 1504 may be configured to perform various operations (e.g., receiving, monitoring, transmitting) using or otherwise in cooperation with the receiver 1510, the transmitter 1512, or both. For example, the positioning manager 1504 may receive information from the receiver 1510, send information to the transmitter 1512, or be integrated in combination with the receiver 1510, the transmitter 1512, or both to receive information, transmit information, or perform various other operations as described herein. Although the positioning manager 1504 is illustrated as a separate component, in some implementations, one or more functions described with reference to the positioning manager 1504 may be supported by or performed by the processor 1506, the memory 1508, or any combination thereof. For example, the memory 1508 may store code, which may include instructions executable by the processor 1506 to cause the device 1502 to perform various aspects of the present disclosure as described herein, or the processor 1506 and the memory 1508 may be otherwise configured to perform or support such operations.

For example, the positioning manager 1504 may support wireless communication and/or network signaling at a device (e.g., the device 1502, a sidelink network device) in accordance with examples as disclosed herein. The positioning manager 1504 and/or other device components may be configured as or otherwise support an apparatus, such as a sidelink network device (e.g., as a configuring device), including a transceiver; a processor coupled to the transceiver, the processor and the transceiver configured to cause the apparatus to: transmit a request message to request a sidelink positioning reference signal (PRS) processing capability of a responding device; receive a response message indicating the sidelink PRS processing capability of the responding device based at least in part on the transmitted request message; configure a sidelink PRS configuration indicating a respective duration and a respective priority associated with processing at least one sidelink PRS at the responding device with respect to at least one additional sidelink signal received by the responding device; and transmit the sidelink PRS configuration to the responding device.

Additionally, the apparatus (e.g., a sidelink network device as a configuring device) includes any one or combination of: the apparatus comprises at least one of a base station, a roadside unit, a location server, an anchor UE, a reference UE, or a target UE. The processor and the transceiver are configured to cause the apparatus to transmit the request message to request a joint sidelink and Uu interface PRS processing capability of the responding device, and receive the response message indicating the joint sidelink and Uu interface PRS processing capability of the responding device. The joint sidelink and Uu interface PRS processing capability of the responding device is based at least in part on a number of one or more sidelink PRS symbols or Uu interface PRS symbols that the responding device can jointly process and buffer during a configured slot duration. The processor and the transceiver are configured to cause the apparatus to transmit the request message to the responding device as one of an unsolicited request or a solicited request. The processor is configured to cause the apparatus to configure the sidelink PRS configuration with a time duration during which the sidelink PRS has a defined priority with respect to a transmission of additional sidelink data or a non-positioning reference signal. The processor is configured to cause the apparatus to transmit the request message via unicast, groupcast, or broadcast signaling. The time duration comprises a time window or a time interval.

The positioning manager 1504 and/or other device components may be configured as or otherwise support a means for wireless communication and/or network signaling at a sidelink network device as a configuring device, including transmitting a request message to request a sidelink positioning reference signal (PRS) processing capability of a responding device; receiving a response message indicating the sidelink PRS processing capability of the responding device based at least in part on the transmitted request message; configuring a sidelink PRS configuration indicating a respective duration and a respective priority associated with processing at least one sidelink PRS at the responding device with respect to at least one additional sidelink signal received by the responding device; and transmitting the sidelink PRS configuration to the responding device.

Additionally, wireless communication at the configuring device includes any one or combination of: transmitting the request message to request a joint sidelink and Uu interface PRS processing capability of the responding device, and receiving the response message indicating the joint sidelink and Uu interface PRS processing capability of the responding device. The joint sidelink and Uu interface PRS processing capability of the responding device is based at least in part on a number of one or more sidelink PRS symbols or Uu interface PRS symbols that the responding device can jointly process and buffer during a configured slot duration. The method further comprising transmitting the request message to the responding device as one of an unsolicited request or a solicited request. The method further comprising configuring the sidelink PRS configuration with a time duration during which the sidelink PRS has a defined priority with respect to a transmission of additional sidelink data or a non-positioning reference signal.

The processor 1506 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1506 may be configured to operate a memory array using a memory controller. In some other implementations, a memory controller may be integrated into the processor 1506. The processor 1506 may be configured to execute computer-readable instructions stored in a memory (e.g., the memory 1508) to cause the device 1502 to perform various functions of the present disclosure.

The memory 1508 may include random access memory (RAM) and read-only memory (ROM). The memory 1508 may store computer-readable, computer-executable code including instructions that, when executed by the processor 1506 cause the device 1502 to perform various functions described herein. The code may be stored in a non-transitory computer-readable medium such as system memory or another type of memory. In some implementations, the code may not be directly executable by the processor 1506 but may cause a computer (e.g., when compiled and executed) to perform functions described herein. In some implementations, the memory 1508 may include, among other things, a basic I/O system (BIOS) which may control basic hardware or software operation such as the interaction with peripheral components or devices.

The I/O controller 1514 may manage input and output signals for the device 1502. The I/O controller 1514 may also manage peripherals not integrated into the device 1502. In some implementations, the I/O controller 1514 may represent a physical connection or port to an external peripheral. In some implementations, the I/O controller 1514 may utilize an operating system such as iOS®, ANDROID®, MS-DOS®, MS-WINDOWS®, OS/2®, UNIX®, LINUX®, or another known operating system. In some implementations, the I/O controller 1514 may be implemented as part of a processor, such as the processor 1506. In some implementations, a user may interact with the device 1502 via the I/O controller 1514 or via hardware components controlled by the I/O controller 1514.

In some implementations, the device 1502 may include a single antenna 1516. However, in some other implementations, the device 1502 may have more than one antenna 1516, which may be capable of concurrently transmitting or receiving multiple wireless transmissions. The receiver 1510 and the transmitter 1512 may communicate bi-directionally, via the one or more antennas 1516, wired, or wireless links as described herein. For example, the receiver 1510 and the transmitter 1512 may represent a wireless transceiver and may communicate bi-directionally with another wireless transceiver. The transceiver may also include a modem to modulate the packets, to provide the modulated packets to one or more antennas 1516 for transmission, and to demodulate packets received from the one or more antennas 1516.

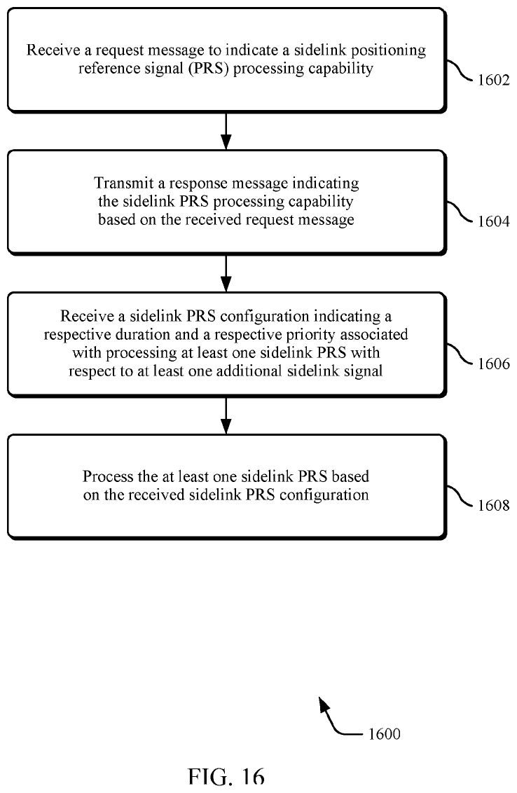

FIG. 16 illustrates a flowchart of a method 1600 that supports sidelink positioning reference signal processing in accordance with aspects of the present disclosure. The operations of the method 1600 may be implemented by a device or its components as described herein. For example, the operations of the method 1600 may be performed by a device, such as a UE 104 configured as a sidelink responding device as described with reference to FIGS. 1 through 15. In some implementations, the device may execute a set of instructions to control the function elements of the device to perform the described functions. Additionally, or alternatively, the device may perform aspects of the described functions using special-purpose hardware.

At 1602, the method may include receiving a request message to indicate a sidelink positioning reference signal (PRS) processing capability. The operations of 1602 may be performed in accordance with examples as described herein. In some implementations, aspects of the operations of 1602 may be performed by a device as described with reference to FIG. 1.

At 1604, the method may include transmitting a response message indicating the sidelink PRS processing capability based on the received request message. The operations of 1604 may be performed in accordance with examples as described herein. In some implementations, aspects of the operations of 1604 may be performed by a device as described with reference to FIG. 1.

At 1606, the method may include receiving a sidelink PRS configuration indicating a respective duration and a respective priority associated with processing at least one sidelink PRS with respect to an additional sidelink signal. The operations of 1606 may be performed in accordance with examples as described herein. In some implementations, aspects of the operations of 1606 may be performed by a device as described with reference to FIG. 1.

At 1608, the method may include processing the at least one sidelink PRS based on the received sidelink PRS configuration. The operations of 1608 may be performed in accordance with examples as described herein. In some implementations, aspects of the operations of 1608 may be performed by a device as described with reference to FIG. 1.

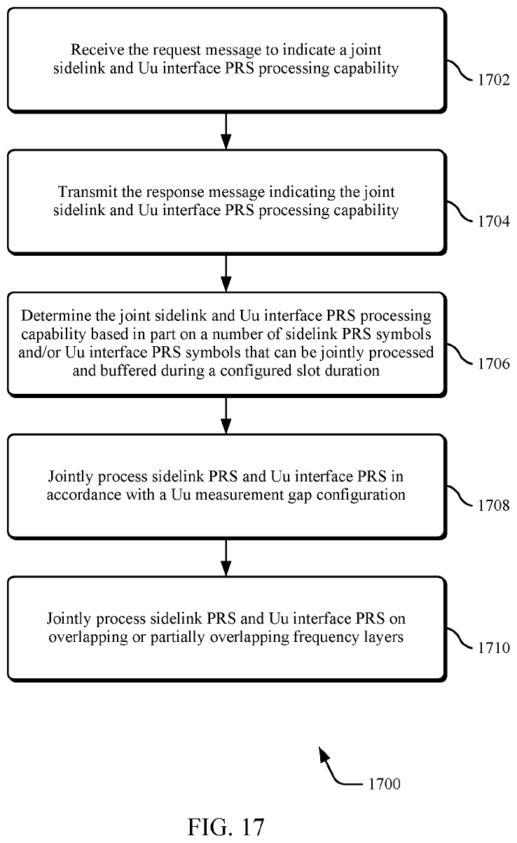

FIG. 17 illustrates a flowchart of a method 1700 that supports sidelink positioning reference signal processing in accordance with aspects of the present disclosure. The operations of the method 1700 may be implemented by a device or its components as described herein. For example, the operations of the method 1700 may be performed by a device, such as a UE 104 configured as a sidelink responding device as described with reference to FIGS. 1 through 15. In some implementations, the device may execute a set of instructions to control the function elements of the device to perform the described functions. Additionally, or alternatively, the device may perform aspects of the described functions using special-purpose hardware.

At 1702, the method may include receiving the request message to indicate a joint sidelink and Uu interface PRS processing capability. The operations of 1702 may be performed in accordance with examples as described herein. In some implementations, aspects of the operations of 1702 may be performed by a device as described with reference to FIG. 1.

At 1704, the method may include transmitting the response message indicating the joint sidelink and Uu interface PRS processing capability. The operations of 1704 may be performed in accordance with examples as described herein. In some implementations, aspects of the operations of 1704 may be performed by a device as described with reference to FIG. 1.

At 1706, the method may include determining the joint sidelink and Uu interface PRS processing capability based on a number of sidelink PRS symbols and/or Uu interface PRS symbols that can be jointly processed and buffered during a configured slot duration. The operations of 1706 may be performed in accordance with examples as described herein. In some implementations, aspects of the operations of 1706 may be performed by a device as described with reference to FIG. 1.

At 1708, the method may include jointly processing sidelink PRS and Uu interface PRS in accordance with a Uu measurement gap configuration. The operations of 1708 may be performed in accordance with examples as described herein. In some implementations, aspects of the operations of 1708 may be performed by a device as described with reference to FIG. 1.

At 1710, the method may include jointly processing sidelink PRS and Uu interface PRS on overlapping or partially overlapping frequency layers. The operations of 1710 may be performed in accordance with examples as described herein. In some implementations, aspects of the operations of 1710 may be performed by a device as described with reference to FIG. 1.

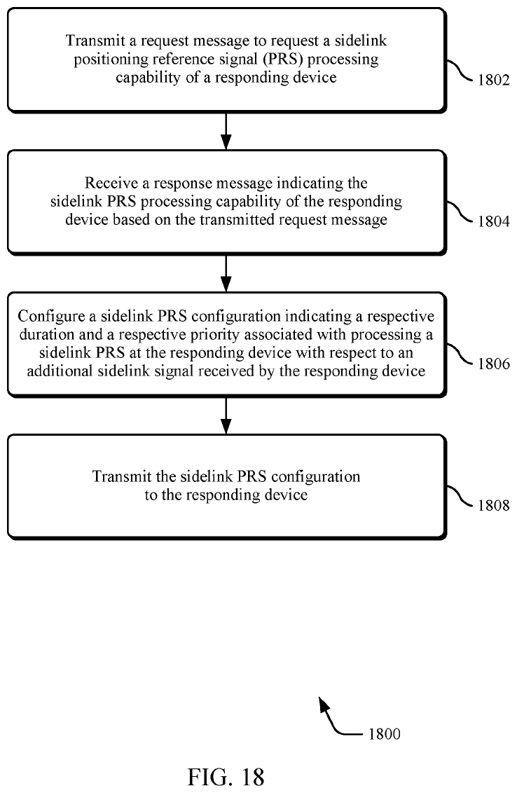

FIG. 18 illustrates a flowchart of a method 1800 that supports sidelink positioning reference signal processing in accordance with aspects of the present disclosure. The operations of the method 1800 may be implemented by a device or its components as described herein. For example, the operations of the method 1800 may be performed by a network device configured as a sidelink configuring device, as described with reference to FIGS. 1 through 15. In some implementations, the device may execute a set of instructions to control the function elements of the device to perform the described functions. Additionally, or alternatively, the device may perform aspects of the described functions using special-purpose hardware.

At 1802, the method may include transmitting a request message to request a sidelink positioning reference signal (PRS) processing capability of a responding device. The operations of 1802 may be performed in accordance with examples as described herein. In some implementations, aspects of the operations of 1802 may be performed by a device as described with reference to FIG. 1.

At 1804, the method may include receiving a response message indicating the sidelink PRS processing capability of the responding device based on the transmitted request message. The operations of 1804 may be performed in accordance with examples as described herein. In some implementations, aspects of the operations of 1804 may be performed by a device as described with reference to FIG. 1.

At 1806, the method may include configuring a sidelink PRS configuration indicating a respective duration and a respective priority associated with processing at least one sidelink PRS at the responding device with respect to an additional sidelink signal received by the responding device. The operations of 1806 may be performed in accordance with examples as described herein. In some implementations, aspects of the operations of 1806 may be performed by a device as described with reference to FIG. 1.

At 1808, the method may include transmitting the sidelink PRS configuration to the responding device. The operations of 1808 may be performed in accordance with examples as described herein. In some implementations, aspects of the operations of 1808 may be performed by a device as described with reference to FIG. 1.

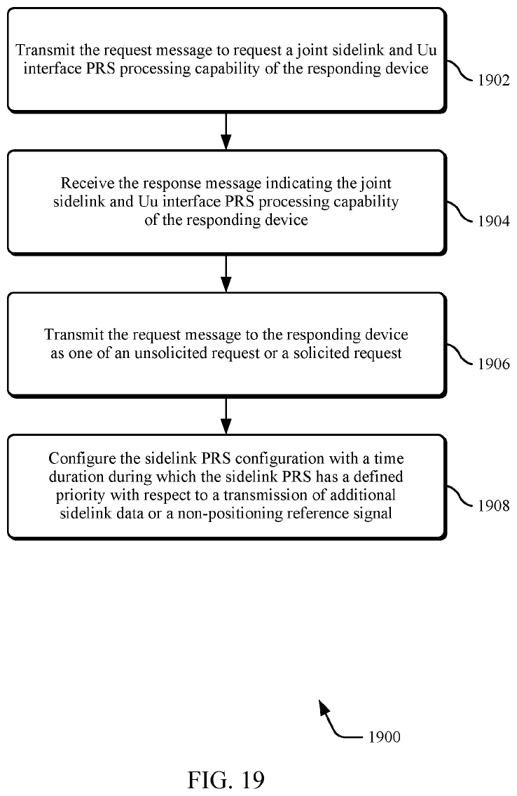

FIG. 19 illustrates a flowchart of a method 1900 that supports sidelink positioning reference signal processing in accordance with aspects of the present disclosure. The operations of the method 1900 may be implemented by a device or its components as described herein. For example, the operations of the method 1900 may be performed by a network device configured as a sidelink configuring device, as described with reference to FIGS. 1 through 15. In some implementations, the device may execute a set of instructions to control the function elements of the device to perform the described functions. Additionally, or alternatively, the device may perform aspects of the described functions using special-purpose hardware.

At 1902, the method may include transmitting the request message to request a joint sidelink and Uu interface PRS processing capability of the responding device. The operations of 1902 may be performed in accordance with examples as described herein. In some implementations, aspects of the operations of 1902 may be performed by a device as described with reference to FIG. 1.

At 1904, the method may include receiving the response message indicating the joint sidelink and Uu interface PRS processing capability of the responding device. The operations of 1904 may be performed in accordance with examples as described herein. In some implementations, aspects of the operations of 1904 may be performed by a device as described with reference to FIG. 1.

At 1906, the method may include transmitting the request message to the responding device as an unsolicited request or a solicited request. The operations of 1906 may be performed in accordance with examples as described herein. In some implementations, aspects of the operations of 1906 may be performed by a device as described with reference to FIG. 1.

At 1908, the method may include configuring the sidelink PRS configuration with a time duration during which the sidelink PRS has a defined priority with respect to a transmission of additional sidelink data or a non-positioning reference signal. The operations of 1908 may be performed in accordance with examples as described herein. In some implementations, aspects of the operations of 1908 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive a request message to indicate a sidelink positioning reference signal (PRS) processing capability of the UE;
transmit a response message indicating the sidelink PRS processing capability of the UE based at least in part on the received request message;
receive a sidelink PRS configuration in accordance with the sidelink PRS processing capability; and
process at least one sidelink PRS based at least in part on the received sidelink PRS configuration.

2. The UE of claim 1, wherein the at least one processor is configured to cause the UE to:
receive the request message to indicate a joint sidelink and Uu interface PRS processing capability of the UE; and
transmit the response message indicating the joint sidelink and Uu interface PRS processing capability of the UE.

3. The UE of claim 2, wherein the at least one processor is configured to cause the UE to determine the joint sidelink and Uu interface PRS processing capability based at least in part on a number of one or more sidelink PRS symbols or Uu interface PRS symbols that the UE can jointly process and buffer during a configured slot duration.

4. The UE of claim 2, wherein the at least one processor is configured to cause the UE to jointly process sidelink PRS and Uu interface PRS in accordance with a Uu measurement gap configuration.

5. The UE of claim 2, wherein a separate sidelink measurement occasion is defined during which to perform sidelink PRS positioning measurements or joint sidelink and Uu interface PRS measurements according to a measurement gap having a start time, a length, a repetition period, and an offset.

6. The UE of claim 1, wherein the response message indicating the sidelink PRS processing capability includes information comprising sidelink PRS symbols that the UE can process according to the sidelink PRS configuration.

7. The UE of claim 1, wherein the response message indicating the sidelink PRS processing capability includes information comprising an amount of sidelink PRS resources that the UE can process in a sidelink slot depending on a sidelink positioning frequency layer.

8. The UE of claim 1, wherein the sidelink PRS configuration comprises criteria of sidelink PRS prioritization as at least one of a first priority state of the sidelink PRS processing having a higher priority than at least one sidelink PRS data processing, or a second priority state of the sidelink PRS processing having a lower priority than the at least one sidelink PRS data processing.

9. An apparatus, comprising:
at least one memory; and
at least one processor coupled with the at least one memory and configured to cause the apparatus to:
transmit a request message to request a sidelink positioning reference signal (PRS) processing capability of a responding device;
receive a response message indicating the sidelink PRS processing capability of the responding device based at least in part on the transmitted request message;
configure a sidelink PRS configuration indicating a respective duration and a respective priority associated with processing at least one sidelink PRS at the responding device with respect to at least one additional sidelink signal received by the responding device; and
transmit, to the responding device, the sidelink PRS configuration.

10. The apparatus of claim 9, wherein the at least one processor is configured to cause the apparatus to:
transmit the request message to request a joint sidelink and Uu interface PRS processing capability of the responding device; and
receive the response message indicating the joint sidelink and Uu interface PRS processing capability of the responding device.

11. The apparatus of claim 10, wherein the joint sidelink and Uu interface PRS processing capability of the responding device is based at least in part on a number of one or more sidelink PRS symbols or Uu interface PRS symbols that the responding device can jointly process and buffer during a configured slot duration.

12. The apparatus of claim 9, wherein the at least one processor is configured to cause the apparatus to transmit the request message to the responding device as one of an unsolicited request or a solicited request.

13. The apparatus of claim 9, wherein the at least one processor is configured to cause the apparatus to configure the sidelink PRS configuration with a time duration during which the sidelink PRS has a defined priority with respect to a transmission of additional sidelink data or a non-positioning reference signal.

14. A method performed by a user equipment (UE), the method comprising:
receiving a request message to indicate a sidelink positioning reference signal (PRS) processing capability;
transmitting a response message indicating the sidelink PRS processing capability based at least in part on the received request message;
receiving a sidelink PRS configuration in accordance with the sidelink PRS processing capability; and
processing at least one sidelink PRS based at least in part on the received sidelink PRS configuration.

15-20. (canceled)

21. A processor for wireless communication, comprising:
at least one controller coupled with at least one memory and configured to cause the processor to:
receive a request message to indicate a sidelink positioning reference signal (PRS) processing capability;
transmit a response message indicating the sidelink PRS processing capability based at least in part on the received request message;
receive a sidelink PRS configuration in accordance with the sidelink PRS processing capability; and
process at least one sidelink PRS based at least in part on the received sidelink PRS configuration.

22. The processor of claim 21, wherein the at least one controller is configured to cause the processor to:
receive the request message to indicate a joint sidelink and Uu interface PRS processing capability; and
transmit the response message indicating the joint sidelink and Uu interface PRS processing capability.

23. The processor of claim 22, wherein the at least one controller is configured to cause the processor to determine the joint sidelink and Uu interface PRS processing capability based at least in part on a number of one or more sidelink PRS symbols or Uu interface PRS symbols that can be jointly processed and buffered during a configured slot duration.

24. The processor of claim 22, wherein the at least one controller is configured to cause the processor to jointly process sidelink PRS and Uu interface PRS in accordance with a Uu measurement gap configuration.

25. The processor of claim 22, wherein a separate sidelink measurement occasion is defined during which to perform sidelink PRS positioning measurements or joint sidelink and Uu interface PRS measurements according to a measurement gap having a start time, a length, a repetition period, and an offset.

26. The processor of claim 21, wherein the response message indicating the sidelink PRS processing capability includes information comprising one of sidelink PRS symbols that can be processed according to the sidelink PRS configuration, or an amount of sidelink PRS resources that can be processed in a sidelink slot depending on a sidelink positioning frequency layer.
